(19) United States
(12) Patent Application Publication
(10) Pub. No.: US 2023/0244533 A1
(43) Pub. Date: Aug. 3, 2023

(54) METHODS AND APPARATUS TO ASYNCHRONOUSLY MONITOR PROVISIONING TASKS

(71) Applicant: VMware, Inc., Palo Alto, CA (US)

(72) Inventors: Sudershan Bhandari, Burlington, MA (US); Teresa Rosa, Burlington, MA (US); Bruce Glenn McElhoe, Cambridge, MA (US); Jie Shang, Burlington, MA (US)

(21) Appl. No.: 17/587,979

(22) Filed: Jan. 28, 2022

(51) Int. Cl. G06F 9/50

(52) U.S. Cl. CPC G06F 9/5027

(57) ABSTRACT

Methods, apparatus, systems, and articles of manufacture are disclosed to asynchronously monitor one or more provisioning tasks, the apparatus comprising: task monitor circuitry to monitor the one or more provisioning tasks, information provider circuitry to generate a task subscription corresponding to the one or more provisioning tasks, and asynchronous property collector circuitry to: create a property filter in the task subscription, request an indication of availability of a status update corresponding to the one or more provisioning tasks based on the property filter, asynchronously provision a second provisioning task that is not blocked by the one or more provisioning tasks, and in response to the availability of the status update, invoke a callback corresponding to a first completion status update or a first progress status update.

### FIELD OF THE DISCLOSURE

This disclosure relates generally to cloud computing and, more particularly, to methods and apparatus to asynchronously monitor provisioning tasks.

### BACKGROUND

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may be composed of many processing units (e.g., servers). The processing units may be installed in standardized frames, known as racks, which provide efficient use of floor space by allowing the processing units to be stacked vertically. The racks may additionally include other components of a cloud computing environment such as storage devices, networking devices (e.g., switches), etc.

### BRIEF DESCRIPTION OF THE DRAWINGS

FIG. 1 is an illustration of a virtual server rack to implement a virtual cloud computing environment offered by a cloud provider.

FIG. 2 is a block diagram of a cloud management platform.

FIG. 3 is a block diagram of example asynchronous task monitor (ATM) circuitry of the cloud management platform of FIG. 2.

FIG. 4 illustrates structures of example ATM circuitry of the cloud management platform of FIG. 2 performing asynchronous task operations.

FIG. 5A is a first portion of an example class diagram of the ATM circuitry of FIG. 3.

FIG. 5B is a second portion of an example class diagram of the ATM circuitry of FIG. 3.

FIG. 6 is a uniform machine language (UML) diagram of a prior process to provision resources in a synchronous manner.

FIGS. 7 and 8 are UML diagrams that may be used to implement resource provisioning in an asynchronous manner in accordance with teachings of this disclosure.

FIG. 9A shows example provisioning test results of the ATM circuitry of FIG. 3 before the ATM circuitry of FIG. 3 is optimized.

FIG. 9B shows an example provisioning test results of the ATM circuitry of FIG. 3 after the ATM circuitry of FIG. 3 is optimized

FIGS. 10 and 11 are flowcharts representative of example machine readable instructions and/or example operations that may be executed by example processor circuitry to implement the ATM circuitry of FIG. 3 to asynchronously monitor at least one task.

FIG. 12 is a block diagram of an example processing platform including processor circuitry structured to execute the example machine readable instructions and/or the example operations of FIGS. 10 and 11 to implement the ATM circuitry of FIG. 3.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIG. 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 16 is example machine readable instructions that when executed instantiate a callback handler.

FIG. 17 is a class diagram that may be used to describe the features of an UpdateSet in accordance with teachings of this disclosure.

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Cloud computing is based on the deployment of many physical resources across a network, virtualizing the physical resources into virtual resources, and provisioning the virtual resources to perform cloud computing services and applications. In some instances, a virtual machine is generated based on a compilation of the virtual resources in which the virtual resources are based on the virtualization of corresponding physical resources. A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example. Virtual cloud computing uses networks of remote servers, computers and/or computer programs to manage access to centralized resources and/or services, to store, manage, and/or process data. Virtual cloud computing enables businesses and large organizations to scale up information technology (IT) requirements as demand or business needs increase. Virtual cloud computing relies on sharing resources to achieve coherence and economies of scale over a network. In some example cloud computing environments, an organization may store sensitive client data in-house on a private cloud application, but interconnect to a business intelligence application provided on a public cloud software service. In such examples, a cloud may extend capabilities of an enterprise, for example, to deliver a specific business service through the addition of externally available public cloud services. In some examples, cloud computing permits multiple users to access a single server to retrieve and/or update data without purchasing licenses for different applications.

Prior to cloud computing, as resources and data increased based on increased business needs or demands, computing systems required the addition of significantly more data storage infrastructure. Virtual cloud computing accommodates increases in workflows and data storage demands without significant efforts of adding more hardware infrastructure. For example, businesses may scale data storage allocation in a cloud without purchasing additional infrastructure.

Cloud computing comprises a plurality of key characteristics. First, cloud computing allows software to access application programmable interfaces (APIs) that enable machines to interact with cloud software in the same way that a traditional user interface (e.g., a computer desktop) facilitates interaction between humans and computers. Second, cloud computing enables businesses or large organizations to allocate expenses on an operational basis (e.g., on a per-use basis) rather than a capital basis (e.g., equipment purchases). Costs of operating a business using, for example, cloud computing, are not significantly based on purchasing fixed assets but are instead more based on maintenance of existing infrastructure. Third, cloud computing enables convenient maintenance procedures because computing applications are not installed on individual users' physical computers but are instead installed at one or more servers forming the cloud service. As such, software can be accessed and maintained from different places (e.g., from an example virtual cloud).

Information technology (IT) is the application of computers and telecommunications equipment to store, retrieve, transmit and/or manipulate data, often in the context of a business or other enterprise. For example, databases store large amounts of data to enable quick and accurate information storage and retrieval. IT service management refers to the activities (e.g., directed by policies, organized and structured in processes and supporting procedures) that are performed by an organization or part of an organization to plan, deliver, operate and control IT services that meet the needs of customers. IT management may, for example, be performed by an IT service provider through a mix of people, processes, and information technology. In some examples, an IT system administrator is a person responsible for the upkeep, configuration, and reliable operation of computer systems; especially multi-user computers, such as servers that seek to ensure uptime, performance, resources, and security of computers meet user needs. For example, an IT system administrator may acquire, install and/or upgrade computer components and software, provide routine automation, maintain security policies, troubleshoot technical issues, and provide assistance to users in an IT network. An enlarged user group and a large number of service requests can quickly overload system administrators and prevent immediate troubleshooting and service provisioning.

Cloud provisioning is the allocation of cloud provider resources to a customer when a cloud provider accepts a request from a customer. For example, the cloud provider creates a corresponding number of virtual machines and allocates resources (e.g., application servers, load balancers, network storage, databases, firewalls, IP addresses, virtual or local area networks, etc.) to support application operation. In some examples, a virtual machine is an emulation of a particular computer system that operates based on a particular computer architecture, while functioning as a real or hypothetical computer. Virtual machine implementations may involve specialized hardware, software, or a combination of both. Example virtual machines allow multiple operating system environments to co-exist on the same primary hard drive and support application provisioning. Before example virtual machines and/or resources are provisioned to users, cloud operators and/or administrators determine which virtual machines and/or resources should be provisioned to support applications requested by users.

Infrastructure-as-a-Service (also commonly referred to as IaaS) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform that gives an application developer access to infrastructure resources, such as virtualized servers, storage, and networking resources. By providing ready access to the hardware resources required to run an application, the cloud computing platform enables developers to build, deploy, and manage projects at a greater scale and at a faster pace than ever before.

Examples disclosed herein can be used with one or more different types of virtualization environments. Three example types of virtualization environments are: full virtualization, paravirtualization, and operating system (OS) virtualization. Full virtualization, as used herein, is a virtualization environment in which hardware resources are managed by a hypervisor to provide virtual hardware resources to a virtual machine (VM). In a full virtualization environment, the VMs do not have access to the underlying hardware resources. In a typical full virtualization, a host OS with embedded hypervisor (e.g., a VMWARE® ESXI® hypervisor, etc.) is installed on the server hardware. VMs including virtual hardware resources are then deployed on the hypervisor. A guest OS is installed in the VM. The hypervisor manages the association between the hardware resources of the server hardware and the virtual resources allocated to the VMs (e.g., associating physical random-access memory (RAM) with virtual RAM, etc.). Typically, in full virtualization, the VM and the guest OS have no visibility and/or access to the hardware resources of the underlying server. Additionally, in full virtualization, a full guest OS is typically installed in the VM while a host OS is installed on the server hardware. Example virtualization environments include VMWARE® ESX® hypervisor, Microsoft HYPER-V® hypervisor, and Kernel Based Virtual Machine (KVM).

Paravirtualization, as used herein, is a virtualization environment in which hardware resources are managed by a hypervisor to provide virtual hardware resources to a VM, and guest Oss are also allowed to access some or all the underlying hardware resources of the server (e.g., without accessing an intermediate virtual hardware resource, etc.). In a typical paravirtualization system, a host OS (e.g., a Linux-based OS, etc.) is installed on the server hardware. A hypervisor (e.g., the XEN® hypervisor, etc.) executes on the host OS. VMs including virtual hardware resources are then deployed on the hypervisor. The hypervisor manages the association between the hardware resources of the server hardware and the virtual resources allocated to the VMs (e.g., associating RAM with virtual RAM, etc.). In paravirtualization, the guest OS installed in the VM is configured also to have direct access to some or all of the hardware resources of the server. For example, the guest OS can be precompiled with special drivers that allow the guest OS to access the hardware resources without passing through a virtual hardware layer. For example, a guest OS can be precompiled with drivers that allow the guest OS to access a sound card installed in the server hardware. Directly accessing the hardware (e.g., without accessing the virtual hardware resources of the VM, etc.) can be more efficient, can allow for performance of operations that are not supported by the VM and/or the hypervisor, etc.

OS virtualization is also referred to herein as container virtualization. As used herein, OS virtualization refers to a system in which processes are isolated in an OS. In a typical OS virtualization system, a host OS is installed on the server hardware. Alternatively, the host OS can be installed in a VM of a full virtualization environment or a paravirtualization environment. The host OS of an OS virtualization system is configured (e.g., utilizing a customized kernel, etc.) to provide isolation and resource management for processes that execute within the host OS (e.g., applications that execute on the host OS, etc.). The isolation of the processes is known as a container. Thus, a process executes within a container that isolates the process from other processes executing on the host OS. Thus, OS virtualization provides isolation and resource management capabilities without the resource overhead utilized by a full virtualization environment or a paravirtualization environment. Example OS virtualization environments include Linux Containers LXC and LXD, the DOCKER™ container platform, the OPENVZ™ container platform, etc.

In some examples, a data center (or pool of linked data centers) can include multiple different virtualization environments. For example, a data center can include hardware resources that are managed by a full virtualization environment, a paravirtualization environment, an OS virtualization environment, etc., and/or a combination thereof. In such a data center, a workload can be deployed to any of the virtualization environments. In some examples, techniques to monitor both physical and virtual infrastructure, provide visibility into the virtual infrastructure (e.g., VMs, virtual storage, virtual or virtualized networks and their control/management counterparts, etc.) and the physical infrastructure (e.g., servers, physical storage, network switches, etc.).

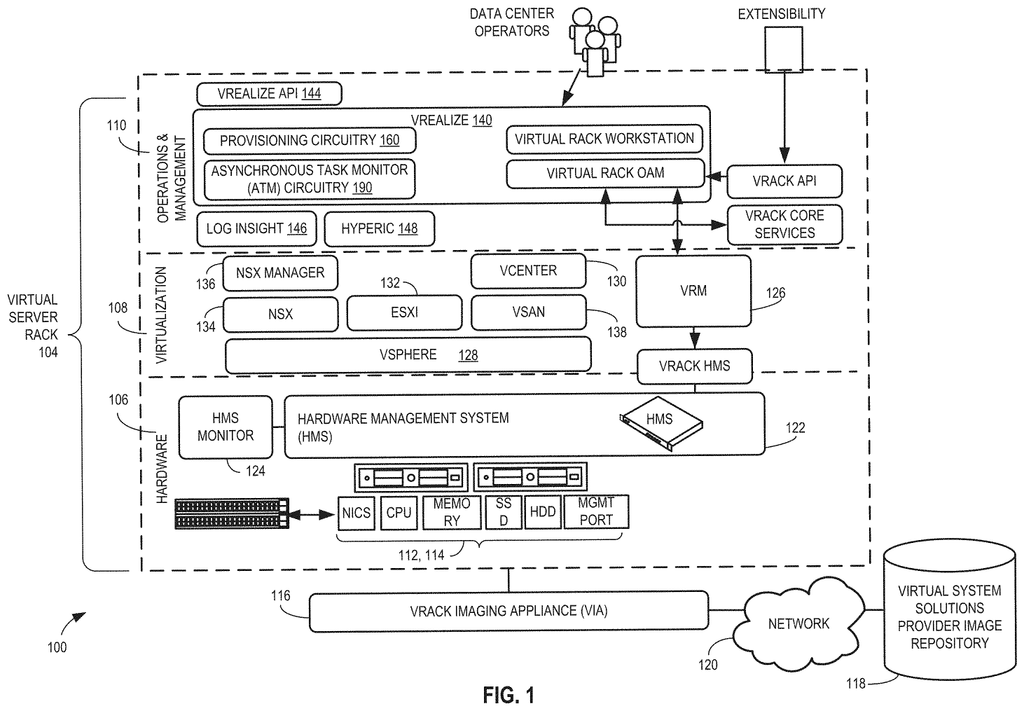

FIG. 1 is an example architecture 100 in which an example virtual imaging appliance (VIA) 116 is utilized to configure and deploy an example virtual server rack 104. The example architecture 100 of FIG. 1 includes a hardware layer 106, a virtualization layer 108, and an operations and management (OAM) component 110. In the illustrated example, the hardware layer 106, the virtualization layer 108, and the operations and management (OAM) component 110 are part of the example virtual server rack 104. The virtual server rack 104 of the illustrated example is based on one or more example physical racks.

Example physical racks are a combination of computing hardware and installed software that may be utilized by a customer to create and/or add to a virtual computing environment. For example, the physical racks may include processing units (e.g., multiple blade servers), network switches to interconnect the processing units and to connect the physical racks with other computing units (e.g., other physical racks in a network environment such as a cloud computing environment), and/or data storage units (e.g., network attached storage, storage area network hardware, etc.). The example physical racks are prepared by the system integrator in a partially configured state to enable the computing devices to be rapidly deployed at a customer location (e.g., in less than 2 hours). For example, the system integrator may install operating systems, drivers, operations software, management software, etc. The installed components may be configured with some system details (e.g., system details to facilitate intercommunication between the components of two or more physical racks) and/or may be prepared with software to collect further information from the customer when the virtual server rack is installed and first powered on by the customer.

The example virtual server rack 104 is configured to configure example physical hardware resources 112, 114 (e.g., physical hardware resources of the one or more physical racks), to virtualize the physical hardware resources 112, 114 into virtual resources, to provision virtual resources for use in providing cloud-based services, and to maintain the physical hardware resources 112, 114 and the virtual resources. The example architecture 100 includes an example virtual imaging appliance (VIA) 116 that communicates with the hardware layer 106 to store operating system (OS) and software images in memory of the hardware layer 106 for use in initializing physical resources needed to configure the virtual server rack 104. In the illustrated example, the VIA 116 retrieves the OS and software images from a virtual system provider image repository 118 via an example network 120 (e.g., the Internet). For example, the VIA 116 is to configure new physical racks for use as virtual server racks (e.g., the virtual server rack 104). That is, whenever a system integrator wishes to configure new hardware (e.g., a new physical rack) for use as a virtual server rack, the system integrator connects the VIA 116 to the new hardware, and the VIA 116 communicates with the virtual system provider image repository 118 to retrieve OS and/or software images needed to configure the new hardware for use as a virtual server rack. In the illustrated example, the OS and/or software images located in the virtual system provider image repository 118 are configured to provide the system integrator with flexibility in selecting to obtain hardware from any of a number of hardware manufacturers. As such, end users can source hardware from multiple hardware manufacturers without needing to develop custom software solutions for each hardware manufacturer. Further details of the example VIA 116 are disclosed in U.S. Patent Application Publication No. 2016/0013974, filed on Jun. 26, 2015, and titled “Methods and Apparatus for Rack Deployments for Virtual Computing Environments,” which is hereby incorporated herein by reference in its entirety.

The example hardware layer 106 of FIG. 1 includes an example hardware management system (HMS) 122 that interfaces with the physical hardware resources 112, 114 (e.g., processors, network interface cards, servers, switches, storage devices, peripherals, power supplies, etc.). The HMS 122 is configured to manage individual hardware nodes such as different ones of the physical hardware resources 112, 114. For example, managing of the hardware nodes involves discovering nodes, bootstrapping nodes, resetting nodes, processing hardware events (e.g., alarms, sensor data threshold triggers) and state changes, exposing hardware events and state changes to other resources and a stack of the virtual server rack 104 in a hardware-independent manner. The HMS 122 also supports rack-level boot-up sequencing of the physical hardware resources 112, 114 and provides services such as secure resets, remote resets, and/or hard resets of the physical hardware resources 112, 114.

In the illustrated example of FIG. 1, the hardware layer 106 includes an example HMS monitor 124 to monitor the operational status and health of the HMS 122. The example HMS monitor 124 is an external entity outside of the context of the HMS 122 that detects and remediates failures in the HMS 122. That is, the HMS monitor 124 is a process that runs outside the HMS daemon to monitor the daemon. For example, the HMS monitor 124 can run alongside the HMS 122 in the same management switch as the HMS 122.

The example virtualization layer 108 includes an example virtual rack manager (VRM) 126. The example VRM 126 communicates with the HMS 122 to manage the physical hardware resources 112, 114. The example VRM 126 creates the example virtual server rack 104 out of underlying physical hardware resources 112, 114 that may span one or more physical racks (or smaller units such as a hyper-appliance or half rack) and handles physical management of those resources. The example VRM 126 uses the virtual server rack 104 as a basis of aggregation to create and provide operational views, handle fault domains, and scale to accommodate workload profiles. The example VRM 126 keeps track of available capacity in the virtual server rack 104, maintains a view of a logical pool of virtual resources throughout the SDDC life-cycle, and translates logical resource provisioning to allocation of physical hardware resources 112, 114. The example VRM 126 interfaces with components of a virtual system solutions provider, such as an example VMware vSphere® virtualization infrastructure components suite 128, an example VMware vCenter® virtual infrastructure server 130, an example ESXi™ hypervisor component 132, an example VMware NSX® network virtualization platform 134 (e.g., a network virtualization component or a network virtualizer), an example VMware NSX® network virtualization manager 136, and an example VMware vSAN™ network data storage virtualization component 138 (e.g., a network data storage virtualizer). In the illustrated example, the VRM 126 communicates with these components to manage and present the logical view of underlying resources such as hosts and clusters. The example VRM 126 also uses the logical view for orchestration and provisioning of workloads.

The VMware vSphere® virtualization infrastructure components suite 128 of the illustrated example is a collection of components to setup and manage a virtual infrastructure of servers, networks, and other resources. Example components of the VMware vSphere® virtualization infrastructure components suite 128 include the example VMware vCenter® virtual infrastructure server 130 and the example ESXi™ hypervisor component 132.

The example VMware vCenter® virtual infrastructure server 130 provides centralized management of a virtualization infrastructure (e.g., a VMware vSphere® virtualization infrastructure). For example, the VMware vCenter® virtual infrastructure server 130 provides centralized management of virtualized hosts and virtual machines from a single console to provide IT administrators with access to inspect and manage configurations of components of the virtual infrastructure.

The example ESXi™ hypervisor component 132 is a hypervisor that is installed and runs on servers in the example physical hardware resources 112, 114 to enable the servers to be partitioned into multiple logical servers to create virtual machines.

The example VMware NSX® network virtualization platform 134 (e.g., a network virtualization component or a network virtualizer) virtualizes network resources such as physical hardware switches to provide software-based virtual networks. The example VMware NSX® network virtualization platform 134 enables treating physical network resources (e.g., switches) as a pool of transport capacity. In some examples, the VMware NSX® network virtualization platform 134 also provides network and security services to virtual machines with a policy driven approach.

The example VMware NSX® network virtualization manager 136 manages virtualized network resources such as physical hardware switches to provide software-based virtual networks. In the illustrated example, the VMware NSX® network virtualization manager 136 is a centralized management component of the VMware NSX® network virtualization platform 134 and runs as a virtual appliance on an ESXi host. In the illustrated example, a VMware NSX® network virtualization manager 136 manages a single vCenter server environment implemented using the VMware vCenter® virtual infrastructure server 130. In the illustrated example, the VMware NSX® network virtualization manager 136 is in communication with the VMware vCenter® virtual infrastructure server 130, the ESXi™ hypervisor component 132, and the VMware NSX® network virtualization platform 134.

The example VMware vSAN™ network data storage virtualization component 138 is software-defined storage for use in connection with virtualized environments implemented using the VMware vSphere® virtualization infrastructure components suite 128. The example VMware vSAN™ network data storage virtualization component clusters server-attached hard disk drives (HDDs) and solid state drives (SSDs) to create a shared datastore for use as virtual storage resources in virtual environments.

Although the example VMware vSphere® virtualization infrastructure components suite 128, the example VMware vCenter® virtual infrastructure server 130, the example ESXi™ hypervisor component 132, the example VMware NSX® network virtualization platform 134, the example VMware NSX® network virtualization manager 136, and the example VMware vSAN™ network data storage virtualization component 138 are shown in the illustrated example as implemented using products developed and sold by VMware, Inc., some or all of such components may alternatively be supplied by components with the same or similar features developed and sold by other virtualization component developers.

The virtualization layer 108 of the illustrated example, and its associated components are configured to run virtual machines. However, in other examples, the virtualization layer 108 may additionally or alternatively be configured to run containers. A virtual machine is a data computer node that operates with its own guest operating system on a host using resources of the host virtualized by virtualization software. A container is a data computer node that runs on top of a host operating system without the need for a hypervisor or separate operating system.

The virtual server rack 104 of the illustrated example enables abstracting the physical hardware resources 112, 114. In some examples, the virtual server rack 104 includes a set of physical units (e.g., one or more racks) with each unit including physical hardware resources 112, 114 such as server nodes (e.g., compute+storage+network links), network switches, and, optionally, separate storage units. From a user perspective, the example virtual server rack 104 is an aggregated pool of logic resources exposed as one or more vCenter ESXi™ clusters along with a logical storage pool and network connectivity. In examples disclosed herein, a cluster is a server group in a virtual environment. For example, a vCenter ESXi™ cluster is a group of physical servers in the physical hardware resources 112, 114 that run ESXi™ hypervisors (developed and sold by VMware, Inc.) to virtualize processor, memory, storage, and networking resources into logical resources to run multiple virtual machines that run operating systems and applications as if those operating systems and applications were running on physical hardware without an intermediate virtualization layer.

In the illustrated example, the example OAM component 110 is an extension of a VMware cloud management platform (e.g., vRealize Automation® cloud management platform 140) that relies on the vRealize Automation® functionality and also leverages utilities such as a Log Insight™ log management service 146 and a Hyperic® application management service 148 to deliver a single point of SDDC operations and management. The example OAM component 110 is configured to provide different services such as heat-map service, capacity planner service, maintenance planner service, events and operational view service, and virtual rack application workloads manager service.

In the illustrated example, the vRealize Automation® cloud management platform 140 is a cloud management platform that can be used to build and manage a multi-vendor cloud infrastructure. The example vRealize Automation® cloud management platform 140 provides a plurality of services that enable self-provisioning of virtual machines in private and public cloud environments, physical machines (install OEM images), applications, and IT services according to policies defined by administrators. For example, the vRealize Automation® cloud management platform 140 may include a cloud assembly service to create and deploy machines, applications, and services to a cloud infrastructure, a code stream service to provide a continuous integration and delivery tool for software, and a broker service to provide a user interface to non-administrative users to develop and build templates for the cloud infrastructure when administrators do not need full access for building and developing such templates. The example vRealize Automation® cloud management platform 140 may include a plurality of other services, not described herein, to facilitate building and managing the multi-vendor cloud infrastructure. In some examples, the example vRealize Automation® cloud management platform 140 may be offered as an on-premise (e.g., on-prem) software solution wherein the vRealize Automation® cloud management platform 140 is provided to an example customer to run on the customer servers and customer hardware. In other examples, the example vRealize Automation® cloud management platform 140 may be offered as a Software as a Service (e.g., SaaS) wherein at least one instance of the vRealize Automation® cloud management platform 140 is deployed on a cloud provider (e.g., Amazon Web Services).

In the illustrated example, a heat map service of the OAM component 110 exposes component health for hardware mapped to virtualization and application layers (e.g., to indicate good, warning, and critical statuses). The example heat map service also weighs real-time sensor data against offered service level agreements (SLAs) and may trigger some logical operations to make adjustments to ensure continued SLA.

In the illustrated example, the capacity planner service of the OAM component 110 checks against available resources and looks for potential bottlenecks before deployment of an application workload. The example capacity planner service also integrates additional rack units in the collection/stack when capacity is expanded.

In the illustrated example, the maintenance planner service of the OAM component 110 dynamically triggers a set of logical operations to relocate virtual machines (VMs) before starting maintenance on a hardware component to increase the likelihood of substantially little or no downtime. The example maintenance planner service of the OAM component 110 creates a snapshot of the existing state before starting maintenance on an application. The example maintenance planner service of the OAM component 110 automates software upgrade/maintenance by creating clones of machines, upgrading software on clones, pausing running machines, and attaching clones to a network. The example maintenance planner service of the OAM component 110 also performs rollbacks if upgrades are not successful.

In the illustrated example, an events and operational views service of the OAM component 110 provides a single dashboard for logs by feeding to a Log Insight™ log management service 146. The example events and operational views service of the OAM component 110 also correlates events from the heat map service against logs (e.g., a server starts to overheat, connections start to drop, lots of HTTP/503 from App servers). The example events and operational views service of the OAM component 110 also creates a business operations view (e.g., a top down view from Application Workloads=>Logical Resource View=>Physical Resource View). The example events and operational views service of the OAM component 110 also provides a logical operations view (e.g., a bottom up view from Physical resource view=>vCenter ESXi Cluster View=>VM's view).

In the illustrated example, the virtual rack application workloads manager service of the OAM component 110 uses vRealize Automation (vRA) and vRA enterprise services to deploy applications to vSphere hosts. The example virtual rack application workloads manager service of the OAM component 110 uses data from the heat map service, the capacity planner service, the maintenance planner service, and the events and operational views service to build intelligence to pick the best mix of applications on a host (e.g., not put all high CPU intensive apps on one host). The example virtual rack application workloads manager service of the OAM component 110 optimizes applications and virtual storage area network (vSAN) arrays to have high data resiliency and the best possible performance achievable at the same time.

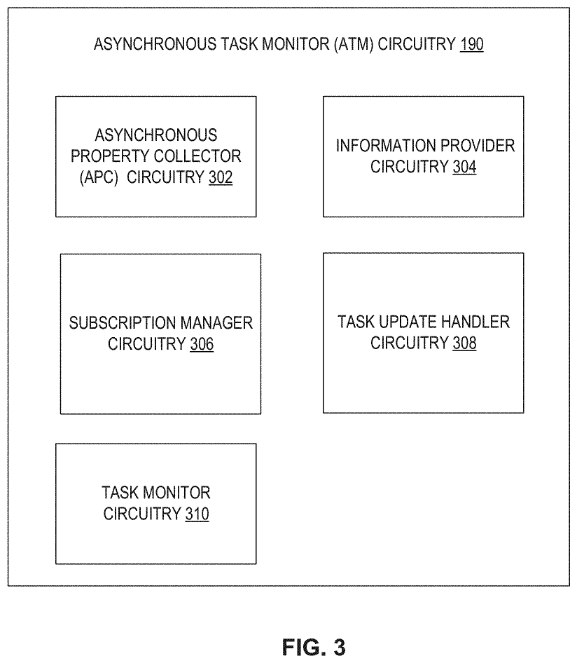

In the illustrated example of FIG. 1, the architecture 100 includes example asynchronous task monitor (ATM) circuitry 190. The example ATM circuitry 190 is a component of the vRealize Automation® cloud management platform 140. The example ATM circuitry 190 is in communication with example provisioning circuitry 160 (e.g., a provisioning engine) and the example vRealize Automation® cloud management platform API 144 (e.g., vRealize API 144). The example ATM circuitry 190 is provided to asynchronously monitor provisioning tasks which allows more asynchronous tasks to be provisioned with the example provisioning circuitry 160 than prior techniques (e.g., prior task-blocking synchronous techniques). The example ATM circuitry 190 is described in further detail below in connection with FIG. 3.

Although the example vRealize Automation® cloud management platform 140, the example Log Insight™ log management service 146, the example Hyperic® application management service 148, and the example ATM circuitry 190 are shown in the illustrated example as implemented using products developed and sold by VMware, Inc., some or all of such components may alternatively be supplied by components with the same or similar features developed and sold by other virtualization component developers. For example, the utilities leveraged by the cloud automation center may be any type of cloud computing platform and/or cloud management platform that delivers and/or provides management of the virtual and physical components of the architecture 100.

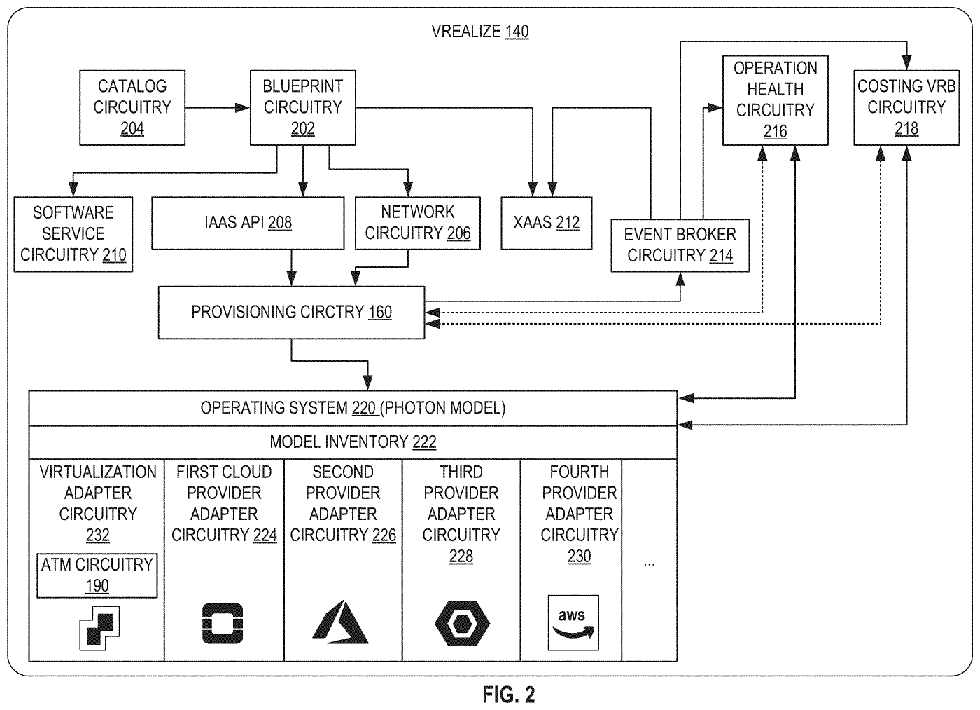

FIG. 2 is a block diagram of a cloud management platform such as the example vRealize Automation® cloud management platform 140 developed and sold by Vmware, Inc. The example vRealize Automation® cloud management platform 140 is a provisioning service with networked discrete components used in the deployment and lifecycle management of different cloud infrastructure resources. The example vRealize Automation® cloud management platform 140 includes example blueprint circuitry 202, example catalog circuitry 204, example network circuitry 206, example Infrastructure-As-A-Service (IAAS) API 208, example software service circuitry 210, example Anything-As-A-Service (XAAS) circuitry 212, example event broker circuitry 214, example operation health circuitry 216, example costing vRealize business circuitry 218, and the example provisioning circuitry 160. The example provisioning circuitry 160 is in circuit with an example Photon OS model 220 which includes an example model inventory 222. The example model inventory 222 includes example first cloud provider adapter circuitry 224, example second cloud provider adapter circuitry 226, example third cloud provider adapter circuitry 228, example fourth cloud provider adapter circuitry 230, and an example virtualization adapter circuitry 232 which includes the example ATM circuitry 190 of FIG. 1.

The example blueprint circuitry 202 (e.g., blueprint service) generates (e.g., creates) and publishes simple blueprints. In examples disclosed herein, a simple blueprint is to provision a single machine (e.g., a virtual machine). In some examples, the blueprint circuitry 202 is to generate complex blueprints corresponding to multiple machines (e.g., multiple virtual machines), multiple networks (as added by the example network circuitry 206), multiple security groups and multiple load balancers. The example catalog circuitry 204 lists (e.g., provides) the example blueprints that are available to be deployed by individual endpoint users. The example IAAS API layer 208 is an example service application interface implemented in the software architectural style of Representational State Transfer (REST) to deploy and manage the lifecycle of virtual machines, virtual networks, load balancers and other resources for different cloud endpoints. The example vRealize Automation® cloud management platform 140 is provided with the IAAS API layer 208 to enable interworking communications between the example provisioning circuitry 160 and the example blueprint circuitry 202.

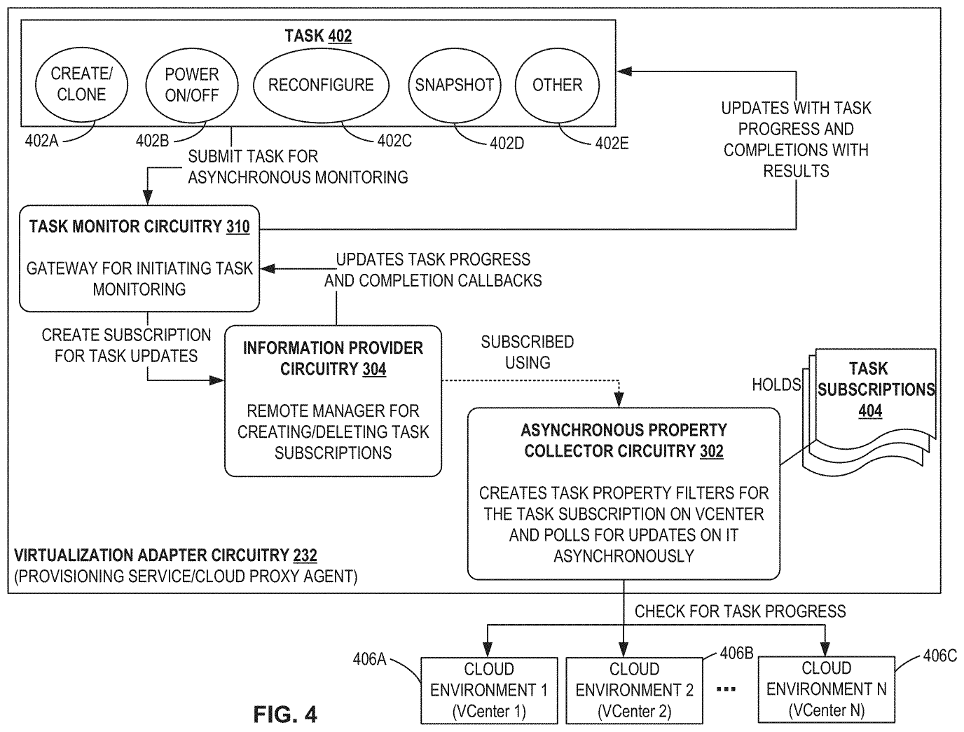

The example provisioning circuitry 160 (e.g., provisioning engine, lifecycle management service circuitry) is to deploy and manage the lifecycle of virtual machines (e.g., workloads), virtual networks, load balancers, and other cloud infrastructure resources for different cloud endpoints. As used herein, a cloud endpoint is a cloud provider where a virtual machine may be provisioned. In examples disclosed herein, different cloud endpoints (e.g., different cloud providers) are different from one another, and thus have different cloud provider adapter circuitry 224, 226, 228, 230, and/or virtualization adapter circuitry 232 from one another. In the example of FIG. 2, the first cloud provider adapter circuitry 224 corresponds to, for example, a VIO/OpenStack cloud provider, and the second cloud provider adapter circuitry 226 corresponds to, for example, a Microsoft Azure cloud provider. Also, in the example of FIG. 2, the third cloud provider adapter circuitry 228 corresponds to, for example, a Google Cloud Platform cloud provider, and the fourth cloud provider adapter circuitry 230 corresponds to, for example, an Amazon Web Services cloud provider. However, any one or more of the cloud provider adapter circuitry 224, 226, 228, 230 and/or the virtualization adapter circuitry 232 may correspond to any other cloud provider. In the example of FIG. 2, the virtualization adapter circuitry 232 (e.g., the fifth cloud provider adapter circuitry), which includes the example ATM circuitry 190, corresponds to a vSphere provider (e.g., a vCenter cloud provider, vSphere cloud provider cloud provider version VMC). However, in other examples, the virtualization adapter circuitry 232 may be used with other cloud providers that use a vSphere-specific API to retrieve updates on example tasks (e.g., the tasks 402 of FIG. 4). The example model inventory 222 is implemented by the example operating system 220 (e.g., Photon Model, Photon Operating System). In some examples the operating system 220 may be implemented by the VMware, Inc. Photon Operating System which is an open-source minimalist Linux operating system optimized for cloud computing platforms, VMware, Inc. vSphere deployments, and applications native to the cloud.

In some examples, the virtualization adapter circuitry 232 is resilient to reboots due to information tracking of provisioning requests persistent in a database so that if there is a reboot, the provisioning requests may be retrieved. In some examples, the virtualization adapter circuitry 232 is configured to detect when long-running tasks (e.g., tasks that are running longer than a timeout threshold such as two hours) are still active and notify the provisioning circuitry 160 of such long-running tasks being active.

FIG. 3 is a block diagram of asynchronous task monitor (ATM) circuitry 190 configured to asynchronously monitor provisioning tasks (e.g., a provisioning task or post-provisioning management task). As used herein, a post-provisioning task is a follow-up task performed on a provisioned resource after a virtual machine is deployed. In some examples, a post-provisioning task is sometimes referred to as a Day-2 task because post-provisioning tasks are performed after provisioning tasks are complete (e.g., any time after, such as the day after, provisioning is complete, after a virtual machine is deployed). Some examples of Day-2 tasks include tasks to add memory and/or reconfigure memory of the deployed virtual machine to a certain memory value, tasks to reconfigure a Central Processing Unit (CPU) of the deployed virtual machine. Other examples of Day-2 tasks include tasks to add additional disks, tasks to add additional network adapters or network interface cards (NICs), customization tasks to apply a customization specification to the deployed virtual machine such as assigning a static Internet Protocol (IP) address. By asynchronously monitoring provisioning of tasks, the example ATM circuitry 190 enables the provisioning of more tasks than could be provisioned using a blocking synchronous method. The example ATM circuitry 190 of FIG. 3 may be instantiated (e.g., creating an instance of, bring into being for any length of time, materialize, implement, etc.) by processor circuitry such as a central processing unit executing instructions. Additionally or alternatively, the ATM circuitry 190 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example ATM circuitry 190 includes example asynchronous property collector (APC) circuitry 302, example information provider circuitry 304, example subscription manager circuitry 306, example task update handler circuitry 308, and example task monitor circuitry 310.

The example asynchronous property collector (APC) circuitry 302 is to generate filters based on task properties. For example, the APC circuitry 302 uses the filters to poll for updates asynchronously about the tasks that are currently being provisioned by the example provisioning circuitry 160 (FIGS. 1, 2). For example, the APC circuitry 302 may use an example filter (e.g., a cloud provider filter) to selectively send a status query (e.g., selectively poll for status of tasks) to a particular cloud service to request information indicative of the status of tasks. In this manner, the example cloud provider filter allows the APC circuitry 302 to selectively communicate with a particular cloud service to determine whether that particular cloud service can accept more provisioning requests. The example APC circuitry 302 uses the example filter to selectively poll for status updates on the monitored tasks. The example filter is to determine (e.g., specify) the objects being monitored (e.g., watched, polled) in the VMware vCenter® virtual infrastructure server 130 and the properties corresponding to the objects being monitored. For example, the filter (e.g., an API that belongs to VMware vCenter® virtual infrastructure server 130) may specify that the objects to be monitored are the example provisioning tasks 402 by determining the cloud environment 406 where the monitored tasks are being provisioned.

In some examples, the APC circuitry 302 generates at least one filter (e.g., at least one property filter object, “PropertyFilterSpec”). The at least one filter is used with an example “WaitForUpdatesEx”. In some examples, the APC circuitry 302 erases the at least one filter by using a “DestroyPropertyFilter” function rather than waiting for a cloud environment session to terminate which will destroy the at least one filter. In examples disclosed herein, a cloud environment session (e.g., vCenter session) is generated in response to a first task 402, and subsequent provisioning tasks 402 are added to a first cloud environment 406A (FIG. 4) for provisioning during the example cloud environment session. When the example first task 402 is completed (e.g., successfully completed or failure), the example first task 402 is removed from the first filter of the example APC circuitry 302. The ones of the example cloud environment sessions correspond to ones of the example cloud environments 406 (e.g., a first cloud environment session corresponds to a first cloud environment 406A). Once the connection to the ones of the example cloud environments 406 is terminated, the cloud environment session is also terminated.

In some examples, for a sequence of incremental property collection operations, the APC circuitry 302 uses a “WaitforUpdatesEx” function which uses a filter (e.g., filter object) that is available for multiple calls.

In some examples, the example APC circuitry 302 generates a persistent property filter specification with a “CreateFilter” function. The example APC circuitry 302 calls the “CreateFilter” function, and the “CreateFilter” function passes a filter (e.g., filter object) to the “CreateFilter” function, adds the filter to a property collector object, and returns a reference to the new filter generated by the “CreateFilter” function. As used herein, a property collector object is an instance of the APC circuitry 302 in a specific cloud environment session (e.g., a vCenter Cloud Session). The example APC circuitry 302 may add additional filters (e.g., filter objects) to the new filter generated by the “CreateFilter” function. In some examples, a first instance of the APC circuitry 302 in a first cloud environment session may not share the new filter generated by the “CreateFilter” function with a second instance of the APC circuitry 302 in a second cloud environment session.

In some examples, the APC circuitry 302 uses the “WaitForUpdatesEx” function to support a polling mechanism for property collection that is based on a specified wait time (e.g., a “WaitOptions.maxWaitSeconds” value that determines the number of seconds the instance of the APC circuitry 302 is to wait for updates) and other parameters. In some examples, the parameters include the managed object reference to a property collector instance (e.g., an instance of the APC circuitry 302), a version value that identifies sequence value, and the amount of data to transmit in a single response (e.g., “WaitOptions.maxObjectUpdates” value). For example, the version value may identify the sequence value because the first time the example APC circuitry 302 uses (e.g., calls) the “WaitForUpdatesEx” function, an empty string (e.g., “ ”) is used to retrieve a complete set of results for the specified properties, and for subsequent uses (e.g., calls) of the “WaitForUpdatesEx” function, the APC circuitry 302 may use the version value returned in the previous use (e.g., call) of the “WaitForUpdatesEx” function. In some examples, if the APC circuitry 302 does not include the version value, the server (e.g., the server that implements the example ATM circuitry 190, the vRealize Automation® cloud management platform 140, etc.) returns the complete set of results for the specified properties.

In some examples, the value of the “WaitOptions.maxWaitSeconds” value determines whether the example instance of the APC circuitry 302 uses an instant retrieval or a polling model. For example, a wait time of zero seconds (e.g., “0”) uses an instant retrieval model, by having the instance of the APC circuitry 302 check for updates based on a union of all the filters associated with that specific instance of the APC circuitry 302 before returning immediately. For example, a wait time of more than zero seconds (e.g., “1 second”, “5 seconds”, “60 seconds”), the instance of the APC circuitry 302 checks for updates after the wait time has elapsed. The example “WaitForUpdatesEx” function blocks the first thread (e.g., process) until updates occur or until a composite time expires (e.g., a composite time based on the “WaitOptions.maxWaitSeconds” value, the time for the instance of the example APC circuitry 302 to collect the updated property values, and policy for the APC circuitry 302). In some examples, if the composite time expires and there are no updates for the requested properties, the instance of the APC circuitry 302 returns “null” for the response of the “WaitForUpdatesEx” function irrespective if the value for “WaitOptions.maxWaitSeconds” is zero seconds or more than zero seconds. The instance of the example APC circuitry 302 that calls the “WaitForUpdatesEx” function may determine to use the “WaitOptions.maxWaitSeconds” value to be zero seconds or more than zero seconds as the “WaitOptions.maxWaitSeconds” value is configurable.

In some examples, the “WaitOptions.maxWaitSeconds” value is optional, and if “WaitOptions.maxWaitSeconds” is not determined by an endpoint user using the example APC circuitry 302, the instance of the APC circuitry 302 waits as long as possible for updates, blocks the first thread after the data has been retrieved, and waits for an expiration of time with a Transmission Control Protocol (e.g., TCP) connection with the server (e.g., the server that implements the example ATM circuitry 190, the vRealize Automation® cloud management platform 140, etc.). However, the example APC circuitry 302 may use (e.g., call) the “WaitForUpdatesEx” function from a second thread, determine specific updates and stop using the “WaitForUpdatesEx” function, or change the TCP connection expiration time (e.g., “BindingProviderProperties.CONNECT_TIMEOUT”]) to stop the “WaitForUpdatesEx” function from blocking the first thread.

In some examples, using a “WaitOptions.maxWaitSeconds” value of zero seconds only returns the properties of the tasks 402 (FIG. 4) that have changed since the version specified. By returning changed data only, the “WaitForUpdatesEx” function provides better network utilization than the example “RetrieveProperties” function. However, returning an empty set even when there are no updates (e.g., nothing has changed) on the example vCenter® virtual infrastructure server 130 (e.g., vCenter cloud provider, the server that implements the example ATM circuitry 190 and the vRealize Automation® cloud management platform 140, etc.) which may be inefficient.

In some examples, using a “WaitOptions.maxWaitSeconds” value of more than zero seconds blocks the first thread until an update occurs which is an efficient use of network resources and may be cancelled by the endpoint user using the example APC circuitry 302. In some examples, using “WaitOptions.maxWaitSeconds” with a value of more than zero seconds is an efficient use of network resources because only the first thread which is polling for the updates is blocked, which permits (e.g., allows, frees) all the other threads to be unblocked for additional processing.

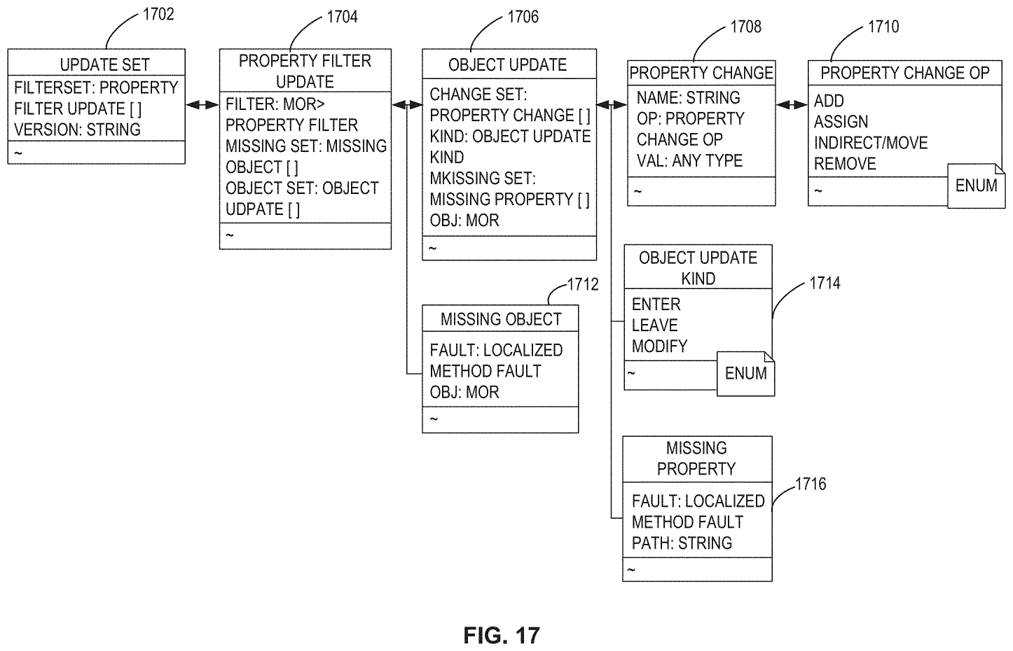

The example “WaitForUpdatesEx” function returns an “UpdateSet data object” as described in connection with FIG. 17.

The example information provider circuitry 304 is to generate (e.g., add) and remove (e.g., delete) task subscriptions (e.g., task subscriptions 404 of FIG. 4) in an example list which is operated by the example subscription manager circuitry 306. As used herein, a task subscription (e.g., a task subscription 404) is a data object that includes a task identifier (e.g., a name) of the task (e.g., a task 402 of FIG. 4) and callback update information (e.g., a completion update or a progress update). The example tasks 402 (e.g., the clone task 402A, the change power task 402B, the reconfigure task 402C, the snapshot task 402D, or the other task 402E) are monitored tasks that are of interest to the example APC circuitry 302. After a task subscription is added to the example subscription manager circuitry 306 (e.g., added to a list stored in memory space or buffer space associated with the example subscription manager circuitry 306), the example task monitor circuitry 310 is instructed to monitor the task 402 that corresponds to the added task subscription. When the example information provider circuitry 304 generates task subscriptions 404 in the example subscription manager circuitry 306 or removes task subscriptions 404 from the example subscription manager circuitry 306, the information provider circuitry 304 provides information from tasks of the task subscriptions 404 to filters of the example APC circuitry 302. The example APC circuitry 302 can then use this information to filter remaining tasks or an updated listing of tasks represented in the subscription manager circuitry 306. After filtering, the update information (e.g., progress update or completion update) about the selected tasks are used by the example APC circuitry 302 to asynchronously provision more tasks in an example provisioning flow. As used herein, a provisioning flow is the set of provisioning tasks 402 that are used to provision a single virtual machine.

In examples disclosed herein, the example subscription manager circuitry 306 stores and/or manages task subscriptions in a list in memory. In some examples, the task subscriptions may be stored permanently (e.g., in a list that does persist in response to a loss in power). The example subscription manager circuitry 306 determines if task subscriptions are configured to receive progress updates or completion updates from the example task monitor circuitry 310. For example, a progress update may be a percentage of a task that is successfully completed (e.g., 25%, 53%, 89%). An example progress update may be in the form of a completion update to indicate a completion status of the task (e.g., success, error, failure, cancelled).

The example task update handler circuitry 308 is to access information provided by the example task monitor circuitry 310. For example, the task update handler circuitry 308 may access task results (e.g., progress result, completion result) from the example task monitor circuitry 310 by using handlers (e.g., a callback handlers) as placeholders to receive the task results before tasks are completed or after the tasks are completed. The example task update handler circuitry 308 provides the information about the task results to the example information provider circuitry 304.

The example ATM circuitry 190 disclosed herein asynchronously monitors one or more provisioning tasks 402 (e.g., long running provisioning tasks or post-provisioning management tasks on provisioned resources). The provisioning tasks 402, once initialized on one or more external cloud computing environments e.g., cloud environments 406A, 406B, 406C FIG. 4, also referred to as cloud environments 406), are pushed from the example provisioning circuitry 160 (e.g., service component of the cloud services) into task monitor circuitry 310 via task subscriptions 404. Such task subscriptions 404 are monitored asynchronously by tracking their progress on example external cloud computing environments 406. Once completed with success or failure, corresponding updates are pushed back to the provisioning circuitry 160 which initiated the task 402. The task completion includes results of the task 402 in case of success and failing reasons in case of failure. The example ATM circuitry 190 allows multiple services to push one or more tasks 402 into the provisioning circuitry 160 without waiting for their completion on different cloud computing environments 406.

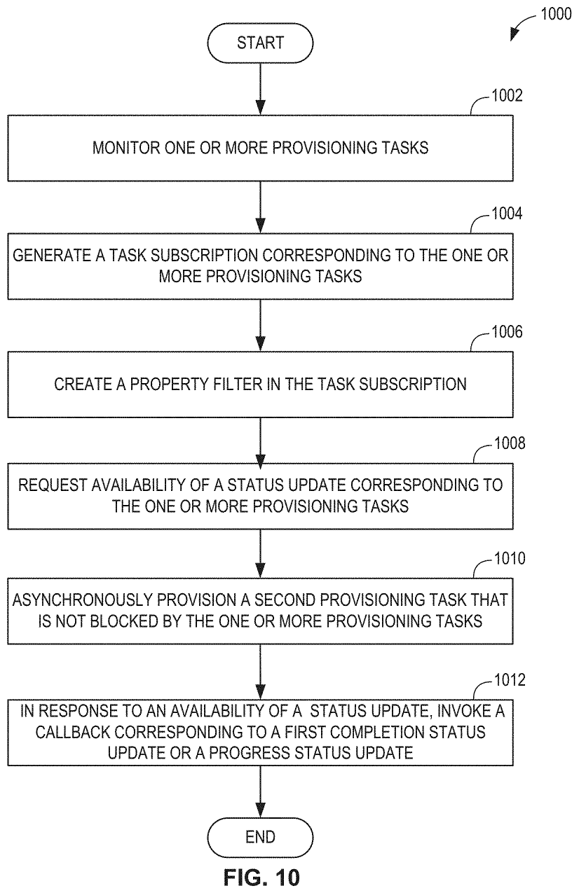

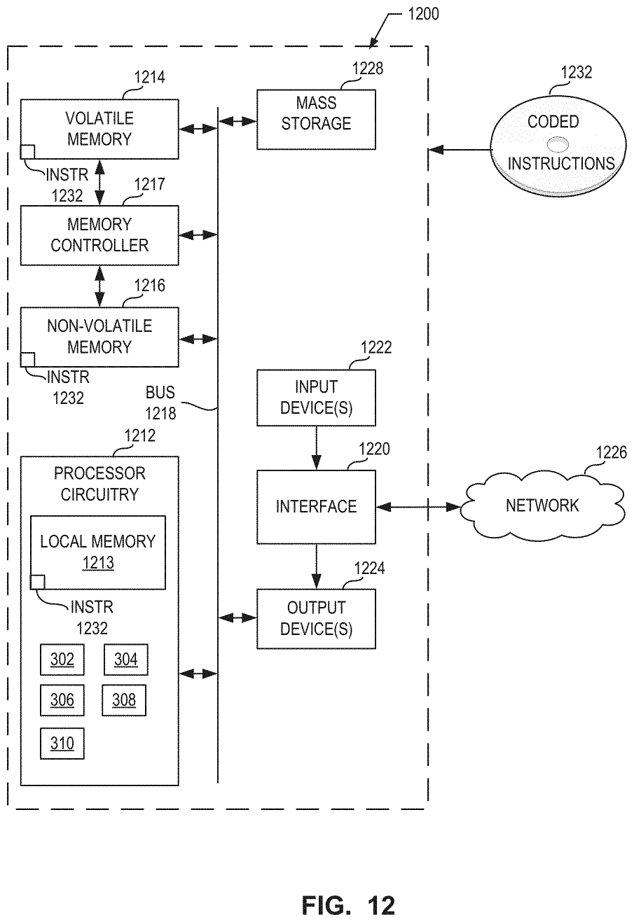

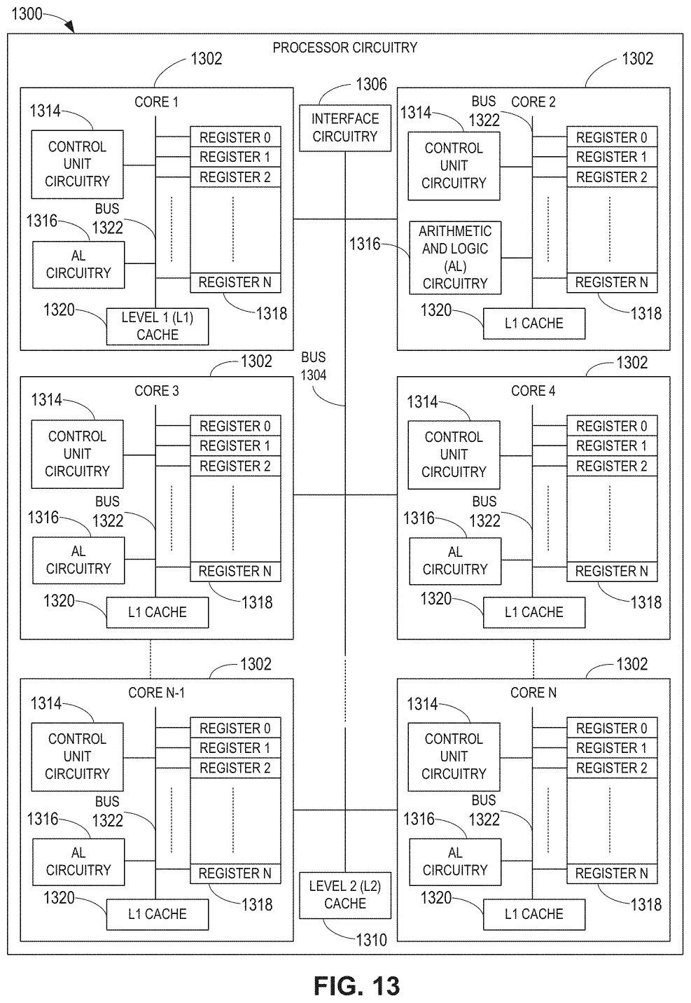

In some examples, apparatus disclosed herein include means for monitoring at least one provisioning task (e.g., provisioning task or post-provisioning management task). For example, the means for monitoring at least one provisioning task may be implemented by the example task monitor circuitry 310. In some examples, the task monitor circuitry 310 may be instantiated by processor circuitry such as the example processor circuitry 1212 of FIG. 12. For instance, the task monitor circuitry 310 may be instantiated by the example general purpose processor circuitry 1200 of FIG. 12 executing machine executable instructions such as that implemented by at least block 1002 of FIG. 10. In some examples, the task monitor circuitry 310 may be instantiated by hardware logic circuitry, which may be implemented by an ASIC or the FPGA circuitry 1300 of FIG. 13 structured to perform operations corresponding to the machine readable instructions. Additionally or alternatively, the task monitor circuitry 310 may be instantiated by any other combination of hardware, software, and/or firmware. For example, the task monitor circuitry 310 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, apparatus disclosed herein include means for generating a task subscription. For example, the means for generating a task subscription may be implemented by the example information provider circuitry 304. In some examples, the information provider circuitry 304 may be instantiated by processor circuitry such as the example processor circuitry 1212 of FIG. 12. For instance, the information provider circuitry 304 may be instantiated by the example general purpose processor circuitry 1200 of FIG. 12 executing machine executable instructions such as that implemented by at least block 1004 of FIG. 10. In some examples, the information provider circuitry 304 may be instantiated by hardware logic circuitry, which may be implemented by an ASIC or the FPGA circuitry 1300 of FIG. 13 structured to perform operations corresponding to the machine readable instructions. Additionally or alternatively, the information provider circuitry 304 may be instantiated by any other combination of hardware, software, and/or firmware. For example, the information provider circuitry 304 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, apparatus disclosed herein include means for generating a property filter. For example, the means for generating a property filter may be implemented by example asynchronous property collector (APC) circuitry 302. In some examples, the APC circuitry 302 may be instantiated by processor circuitry such as the example processor circuitry 1212 of FIG. 12. For instance, the APC circuitry 302 may be instantiated by the example general purpose processor circuitry 1200 of FIG. 12 executing machine executable instructions such as that implemented by at least block 1006 of FIG. 10. In some examples, the APC circuitry 302 310 may be instantiated by hardware logic circuitry, which may be implemented by an ASIC or the FPGA circuitry 1300 of FIG. 13 structured to perform operations corresponding to the machine readable instructions. Additionally or alternatively, the APC circuitry 302 may be instantiated by any other combination of hardware, software, and/or firmware. For example, the APC circuitry 302 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, apparatus disclosed herein include means for providing updates. For example, the means for providing updates may be implemented by example task update handler circuitry 308. In some examples, the task update handler circuitry 308 may be instantiated by processor circuitry such as the example processor circuitry 1212 of FIG. 12. For instance, the task update handler circuitry 308 may be instantiated by the example general purpose processor circuitry 1200 of FIG. 12 executing machine executable instructions such as that implemented by at least blocks 1002, 1004, 1006 of FIG. 10. In some examples, the task update handler circuitry 308 may be instantiated by hardware logic circuitry, which may be implemented by an ASIC or the FPGA circuitry 1300 of FIG. 13 structured to perform operations corresponding to the machine readable instructions. Additionally or alternatively, the task update handler circuitry 308 may be instantiated by any other combination of hardware, software, and/or firmware. For example, the task update handler circuitry 308 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the asynchronous task monitor (ATM) circuitry 190 of FIGS. 1, 2 is illustrated in FIG. 3, one or more of the elements, processes, and/or devices illustrated in FIG. 3 may be combined, divided, re-arranged, omitted, eliminated, and/or implemented in any other way. Further, the example asynchronous property collector (APC) circuitry 302, the example information provider circuitry 304, the example subscription manager circuitry 306, the example task update handler circuitry 308, and the example task monitor circuitry 310 and/or, more generally, the example ATM circuitry 190 of FIGS.-1-3, may be implemented by hardware alone or by hardware in combination with software and/or firmware. Thus, for example, any of the example asynchronous property collector (APC) circuitry 302, the example information provider circuitry 304, the example subscription manager circuitry 306, the example task update handler circuitry 308, and the example task monitor circuitry 310 and/or, more generally, the example ATM circuitry 190, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example ATM circuitry 190 of FIGS. 1-3 may include one or more elements, processes, and/or devices in addition to, or instead of, those illustrated in FIG. 3, and/or may include more than one of any or all of the illustrated elements, processes and devices.

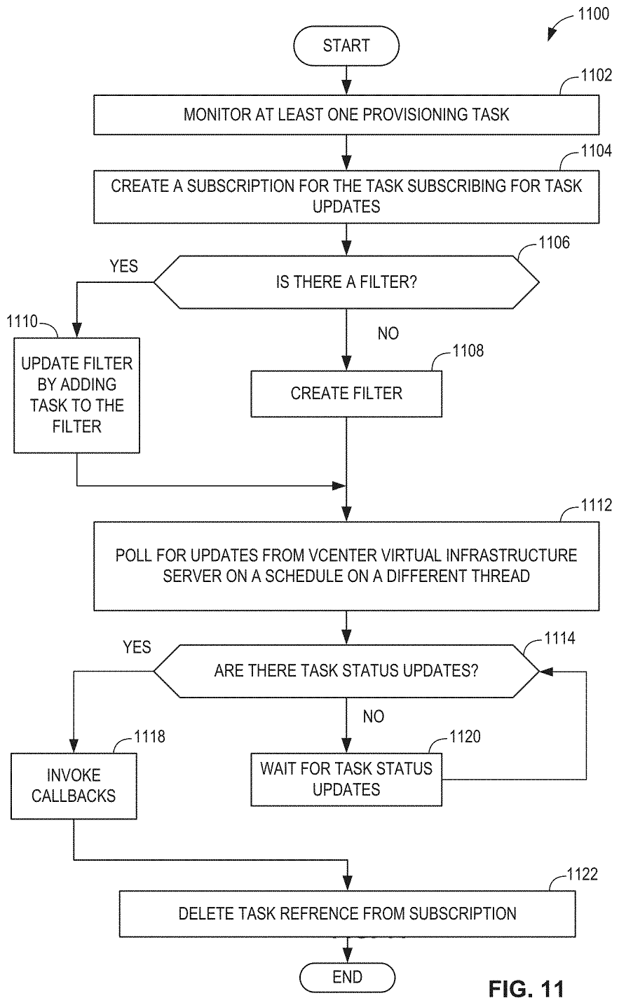

Flowcharts representative of example hardware logic circuitry, machine readable instructions, hardware implemented state machines, and/or any combination thereof for implementing the ATM circuitry 190 of FIGS. 1-3 are shown in FIGS. 10 and 11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 10, many other methods of implementing the example ATM circuitry 190 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 illustrates structures of the example ATM circuitry 190 in the example virtualization adapter circuitry 232 (e.g., vCenter adapter, provisioning service, cloud proxy agent, etc.). In the example of FIG. 4, a plurality of tasks 402 used to provision resources include an example clone task 402A (e.g., Create/Clone), an example change power task 402B (e.g., Power On/Off), an example reconfigure task 402C (e.g., customize after clone), an example snapshot task 402D, and an example other task 402E. The example other task 402E is to represent tasks not previously enumerated by the example clone task 402A, the example change power task 402B, the example reconfigure task 402C, and/or the example snapshot task 402D. For ease of description, one or more of the separate tasks 402A, 402B, 402C, 402D, and 402E are sometimes referred to herein as the tasks 402. The example task monitor circuitry 310 monitors the tasks 402. The example task monitor circuitry 310 may monitor the tasks 402 by determining updates and status of various ones of the tasks 402. Based on techniques disclosed herein, the example task monitor circuitry 310 monitors at least one task (e.g., multiple tasks).

The example task monitor circuitry 310 includes a first function “progressListener” which is to listen (e.g., determine) the progresses of the tasks 402 and report each progress update as a task progress callback. For example, the clone task 402A may be twenty-five percent (25%) complete at a first time, and the example task monitor circuitry 310 can access that progress using the progressListener function. In this example, at a second time the example clone task 402A may be ninety percent (90%) complete at a second time, and the example task monitor circuitry 310 can also access that progress through the progressListener function. The example task monitor circuitry 310 includes a second function “taskResultExtractor” which is to access (e.g., determine) statuses of one or more of the tasks 402 after the tasks 402 are completed and report the status information to information provider circuitry 304 as a completion callback. For example, after completion, the tasks 402 may have a status of success, error, terminated (e.g., canceled, force quit, stopped, etc.), or timeout.

The example information provider circuitry 304 is to generate (e.g., create) and remove (e.g., delete) example task subscriptions 404. The example task subscriptions 404 are managed by the example subscription manager circuitry 306 (FIG. 3). In some examples, the task subscriptions 404 are stored in memory space or buffer space associated with the example subscription manager circuitry 306. As used herein, a “task subscription” includes both information about an example task 402 and the example callback to be called when there are updates from the example task 402. For example, a task subscription 404 may include the name (e.g., identifier) of the task 402 (e.g., TaskID=“Task_4125”) and the callback status identifier (e.g., CompletionCallback=<success, error, terminated>“or ProgressCallback=<percentage complete>). For example, task subscriptions 404 may include a progress callback which is to use the progressListener of the example task monitor circuitry 310 or a completion callback which is to use the taskResultExtractor of the example task monitor circuitry 310.

The monitoring of the tasks 402 is initiated by the example information provider circuitry 304 which creates (e.g., generates) task subscriptions 404 for the tasks 402 being monitored by the example task monitor circuitry 310. The example APC circuitry 302 polls the VMware vCenter® virtual infrastructure server 130 to request whether status updates for one or more of the tasks 402 are available. In this manner, the example APC circuitry 302 may call callbacks for progress status updates or completion status updates. In response to an instruction from the example APC circuitry 302, the example information provider circuitry 304 may delete an example task subscription 404 corresponding to an example task 402 that has a completion status. In some examples, requests for further provisioning tasks 402 can come from blueprint circuitry 202 and then provisioning circuitry 160.

The example APC circuitry 302 (e.g., asynchronous property collector circuitry) is to generate task property filters for the example task subscriptions 404. The example APC circuitry 302 uses the filters to poll for updates asynchronously about the tasks 402 executed on the first cloud environment 406A (e.g., a first vCenter cloud), the second cloud environment 406B (e.g., a second vCenter cloud) and/or the n-th cloud environment 406C (e.g., an n-th vCenter cloud). In some examples, the task subscription 404 is generated in the example virtualization adapter circuitry 232 in the form of task property filters that may be used by the example task monitor circuitry 310 to track tasks 402 of the task subscription 404 for the lifetime of the tasks 402. The example filter has information about the monitored tasks 402 in the cloud environment session (vCenter Cloud Session). Such information is used by the example APC circuitry 302 to make polling calls to retrieve status updates of the tasks 402 that are in progress on one or more of the example cloud environments 406A, 406B, 406C.

In some examples, the APC circuitry 302 uses a first filter to retrieve updates of ones of the tasks 402 executed on the first cloud environment 406A. In some examples, the APC circuitry 302 uses a first filter to retrieve updates of ones of the tasks 402 executed during a first cloud environment session. In examples disclosed herein, a cloud environment session (e.g., vCenter Cloud Session) is generated in response to a first task 402, and the example information provider circuitry 304 generates a task subscription 404 and adds the first provisioning task 402 to the example task subscription 404. Subsequent provisioning tasks 402 are added to the first cloud environment 406A for provisioning during the example cloud environment session and are added to the example task subscription 404 for monitoring. When the example first task 402 is completed (e.g., successfully completed or failure), the example first task 402 is removed from the task subscription 404 which removes the first task 402 from the first filter of the example APC circuitry 302. The cloud environment session is terminated (e.g., closed) in response to the connection to the vCenter server 300 which supports the cloud environments 406 is closed.

In some examples, for multiple ones of the cloud environments 406 the example APC circuitry 302 (e.g., the first cloud environment 406A, the second cloud environment 406B), a corresponding separate cloud environment session is established. In these examples, there is at least one instance of the APC circuitry 302 (e.g., at least one property collector) that is generated for ones of the different cloud environment sessions. For example, for different ones of the monitored cloud environments 406, a separate set of tasks is monitored by the example ATM circuitry 190. In some examples, the cloud environment session is not closed when the example task monitor circuitry 310 finishes monitoring tasks 402, but rather when the connection to the VMware vCenter® virtual infrastructure server 130 or the ones of the cloud environments 406 is closed.

The example APC circuitry 302 uses the example task monitor circuitry 310 to monitor the tasks 402 on the example cloud environments 406A, 406B, 406C asynchronously, which does not block threads executing in the virtualization adapter circuitry 232. Because the threads are not blocked, the threads are available to process additional provisioning requests from the provisioning circuitry 160 (FIG. 2). When an example task 402 is completed, the example APC circuitry 302 updates the filter to remove the information about that completed task 402, and the example information provider circuitry 304 deletes the task subscription 404 corresponding to the completed task 402.

The performance of the example APC circuitry 302 (e.g., the performance of an API used by the example APC circuitry 302) may be affected by one or more factors. For example, the APC circuitry 302 uses (e.g., calls) an API which polls for updates with the example “WaitForUpdatesEx” function which is affected by the number of objects, properties of the polling, and the frequency of changes to the objects. Examples of such factors include (i) the number of objects (e.g., virtual machines) to be provisioned by the example provisioning circuitry 160, (ii) the number of properties of the number of virtual machines to be provisioned, (iii) a density of the property data (e.g., composite data objects, nested data objects) of the virtual machines to be provisioned, (iv) frequency of changes to objects and properties on a server (e.g., the server that implements the example ATM circuitry 190, the vRealize Automation® cloud management platform 140, etc.), (v) depth of traversal of the properties of the virtual machines to be provisioned (e.g., number of properties traversed), (vi) the number of APC instances (e.g., multiple instances of the APC circuitry 302 may execute concurrently), (vii) the total number of filters supported by the number of APC instances across all cloud environment sessions on the vCenter server 130. Variations in these factors may increase or decrease the performance of the APC circuitry 302. For example, the performance of the APC circuitry 302 may increase based on limiting the number of objects and limiting the number of properties traversed.

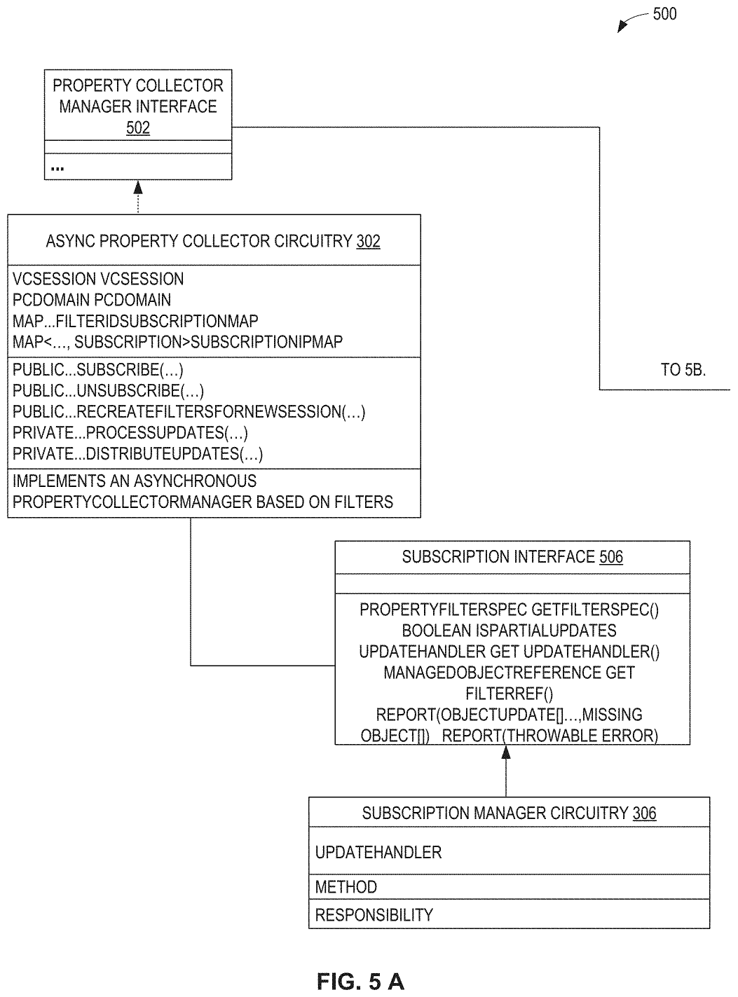

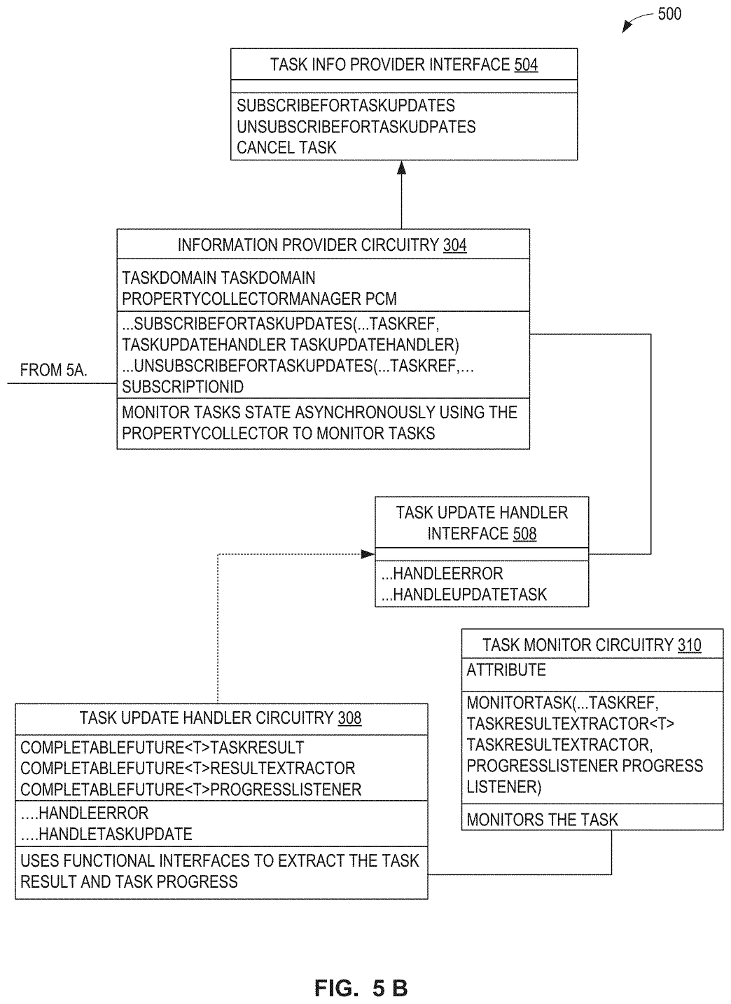

FIG. 5A is a first portion of an example class diagram 500 of functions or methods that may be implemented by the ATM circuitry 190. FIG. 5B is a second portion of the example class diagram 500. The example class diagram 500 illustrates the example APC circuitry 302 (FIG. 5A), an example property collector manager interface 502 (FIG. 5A), the example subscription manager circuitry 306 (FIG. 5A), an example subscription interface 506 (FIG. 5A), the example information provider circuitry 304 (FIG. 5B), an example task information provider interface 504 (FIG. 5B), the example task update handler circuitry 308 (FIG. 5B), an example task update handler interface 508 (FIG. 5B) and the example task monitor circuitry 310 (FIG. 5B).

Once an example task 402 (FIG. 4) is submitted for provisioning by the provisioning circuitry 160 (FIG. 2), the example APC circuitry 302 submits the example task 402 to the list of the example subscription manager circuitry 306 for monitoring by the task monitor circuitry 310. The example task monitor circuitry 310 uses information about the submitted example task 402 to determine which of the tasks 402 to monitor. The example task monitor circuitry 310 reports the status of the monitored task 402 (e.g., 25%, 50%, success, error, terminated, no update, etc.) to the example information provider circuitry 304 by using the example task update handler circuitry 308 (e.g., an example task update handler implementation) and the example task update handler interface 508. After the monitored task 402 is completed, the example information provider circuitry 304 removes the task 402 from the list of the subscription manager circuitry 306, and the example task monitor circuitry 310 stops monitoring the task 402. The example APC circuitry 302 includes filters based on the different cloud environments 406 (FIG. 4). The example APC circuitry 302 includes the task reference in the task subscription 404 to identify tasks 402). Since the APC circuitry 302 monitors, with a first thread, the progress of the tasks asynchronously in accordance with teachings of this disclosure, other threads are not blocked, and thus the virtualization adapter circuitry 232 is free to start more work (e.g., additional tasks or threads) based on the monitoring of the example task monitor circuitry 310. For example, the provisioning circuitry 160 starts provisioning flows that are directed to the virtualization adapter circuitry 232, and threads of the virtualization adapter circuitry 232 are free to pickup more work based on the monitoring of the example task monitor circuitry 310. In the monitoring, the first thread noted above is the thread that periodically polls for updates using the example “WaitFor UpdatesEx” function and then distributes the updates (e.g., results) corresponding to the tasks 402 that were submitted by different threads.

In a prior, blocking, synchronous process, every time a task was submitted, a different API was invoked to check the status of the submitted task (e.g., a first API that corresponds to a first submitted task, a second API that corresponds to a second submitted task). The APIs were executed in a loop with a sleep call that blocks the thread from doing other provisioning work until the result of the task submitted.

Rather than being blocked by waiting on a result of the task 402 submitted to vCenter® virtual infrastructure server 130 (e.g., vCenter cloud provider, techniques disclosed herein unblock the threads, which allow the threads to do other provisioning work.

The example APC circuitry 302 includes functions (e.g., methods, operations) to perform asynchronous property collections based on filters. The example APC circuitry 302 includes a subscribe function which is to instruct the task information provider interface 504 to subscribe for task updates. The example APC circuitry 302 includes an unsubscribe function which is to instruct the task information provider interface 504 to unsubscribe for task updates. The example APC circuitry 302 includes a recreate filters function which is to generate identical filters for a new cloud environment session based on a previous cloud environment session. In some examples, after a cloud environment session is completed, the corresponding filter is deleted. The example APC circuitry 302 includes a stop monitoring function to terminate the cloud environment session. The example APC circuitry 302 includes a process updates function which is to determine which task updates to distribute to the example provisioning circuitry 160, while an example distribute updates function is to communicate the task updates to the provisioning circuitry 160.

The example property collector manager interface 502 is a set of methods (e.g., a set of methods in Java). The example APC circuitry 302 implements the methods of the property collector manager interface 502, which allows for providing different implementations based on the same interface (e.g., the same property collector manager interface 502). For ease of description in FIG. 5, the example property collector manager interface 502 includes an ellipsis “ . . . ” to illustrate that the set of methods in the example property collector manager interface 502 are the same as or substantially similar to the set of methods in the example APC circuitry 302.

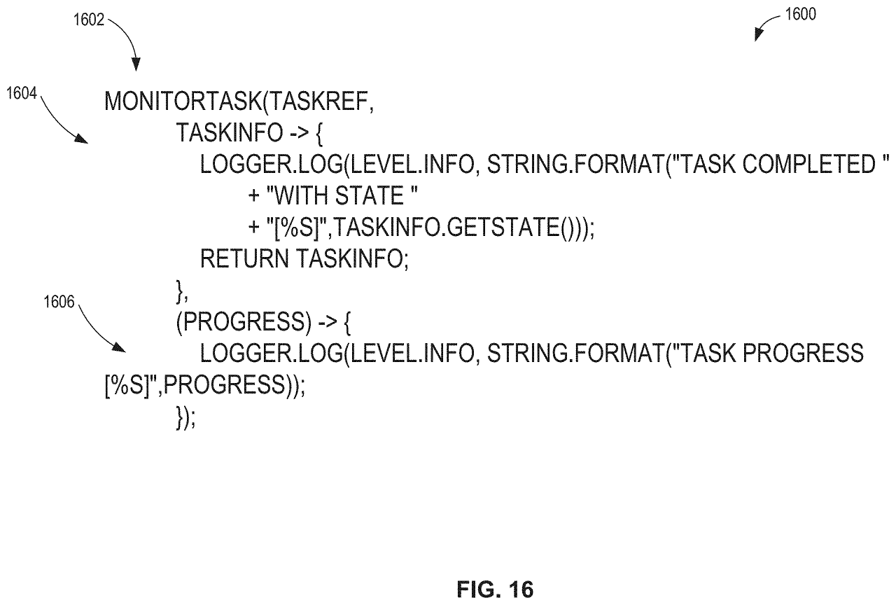

The example subscription interface 506 includes a get-filter-spec function which is to use a Boolean value (isPartialUpdates) to determine if a filter is to retrieve progress updates (e.g., progress callbacks if the Boolean value of isPartialUpdates is true) or completion updates (e.g., completion callbacks if the Booelan value of isPartialUpdates is false). The example subscription interface 506 includes an “UpdateHandler” function which is to communicate to the example task update handler interface 508 and example task update handler circuitry 308 (e.g., task update handler implementation) to remove or add task subscriptions. For example, the “UpdateHandler” function propagates the completion update or the progress update corresponding to the task 402 to an example callback (as described in connection with FIG. 16) used by an example “monitorTask” function executed by the example task monitor circuitry 310. In some examples, the callbacks log the task information (e.g., TaskInfo) or report the progress. The example subscription interface 506 includes a report function which can be used to report an update for an object (e.g., a virtual machine), a missing object error, or a throwable error.

In some examples, the Boolean value (isPartialUpdates) is a flag to indicate if a change to a nested property reports only the nested change or the entire specified property value. For example, if the Boolean value is true, a change reports only the nested property. For example, if the value is false, a change reports the enclosing property named in the filter.

The example subscription manager circuitry 306 includes an example updateHandler method. The example subscription manager circuitry 306 uses the updateHandler method to store and/or manage updates from task subscriptions 404. In some examples, the subscription manager circuitry 306 also translates updates to provisioning tasks 402 received by the VMware vCenter® virtual infrastructure server 130 into updates (e.g., progress updates, completion updates) to the example task monitor circuitry 310 which uses (e.g., calls) the “monitor task” function. The example subscription manager circuitry 306 translates the results from the “WaitForUpdatesEx” function into calls to the progress callback or completion callback. For example, if the ATM circuitry 190 is restarted, the task subscriptions 404 stored in the subscription manager circuitry 306 are deleted (e.g., cleaned, lost, erased). However, the task subscriptions 404 that were deleted in response to a restart of the example ATM circuitry 190 may be recreated if information (e.g., data) corresponding to the task subscriptions 404 is persisted (e.g., persisted in memory and/or storage). For example, the task subscriptions may be stored in different records or entries in memory space associated with the example subscription manager circuitry 306. In some examples, the updateHandler function propagates the update or progress reported on the task 402 to the callback handlers (as described in connection with FIG. 16) used in the monitorTask function of the task monitor circuitry 310. The example subscription manager circuitry 306 determines if task subscriptions 404 are configured to receive progress updates or completion updates from the example task monitor circuitry 310. For example, a progress update may be a percentage of a task that is successfully completed (e.g., 25%, 53%, 89%). An example progress update may be in the form of a completion update to indicate an end state of the task (e.g., success, error, failure, terminated).

As used herein, in connection with FIG. 16, a callback handler is used by the example task update handler circuitry 308 to request a status update from the example task monitor circuitry 310. Results from the example task monitor circuitry 310 are provided to the task update handler circuitry 308 via the callback handler.

The example information provider circuitry 304 (e.g., information provider implementation) is to monitor the status (e.g., state) of tasks asynchronously by using the example APC circuitry 302 to monitor the specific examples of the tasks 402. The example information provider circuitry 304 includes a “subscribe for task updates” function which uses the task reference identification (e.g., taskRef) to add the task subscription 404 to the subscription manager circuitry 306. The example information provider circuitry 304 includes an “unsubscribe for task updates” function which uses the task reference identification (e.g., taskRef) to remove the task subscription 404 from the subscription manager circuitry 306.

The example task information provider interface 504 includes a “subscribe for task updates” function and an “unsubscribe for task updates” function. The example task information provider interface 504 also includes a “cancel task” function which is to cancel the example task 402 in response to a determination that the example task 402 is not on target to be provisioned in a pre-set amount of time.

The example task update handler interface 508 includes a “HandleError” function (e.g., “handleUpdateError” function) which is to report errors when the example task 402 is unable to be provisioned. For example, some errors include (i) the example provisioning circuitry 160 cannot provision cloud infrastructure resources, because the example vCenter® virtual infrastructure server 130 (e.g., vCenter cloud provider, host) is under maintenance and (ii) the example change power task 402B may fail due to there not being enough memory on the example vCenter® virtual infrastructure server 130 (e.g., vCenter cloud provider, host). In some examples, the task update handler interface 508 deals with errors when updates from the example vCenter® virtual infrastructure server 130 (e.g., vCenter cloud provider) are not retrieved by the example ATM circuitry 190. The example task update handler interface 508 deals with errors (e.g., unexpected errors, expected errors) and reports a failure to the example information provider circuitry 304.

The example task update handler interface 508 includes a “handle update task” function which is to receive a task update from the VMware vCenter® virtual infrastructure server 130 for one or more provisioning tasks 402 and the received task update results in the example information provider circuitry 304 using (e.g., calling) the progress callback and completion callback for the one or more provisioning tasks 402. The example task update may include a progress (e.g., 25%, 53%, 89%) or a completion status (e.g., success, error, failure, terminated).

The example task update handler circuitry 308 (e.g., task update handler implementation) uses the functional interface (e.g., the task update handler interface 508) to extract the task result (e.g., success, error, failure, terminated) and the task progress (e.g., 25%, no update/still 25%, 30%). The example task update handler circuitry 308 uses callback handlers for the task result, the result extractor, and the progress listener to store corresponding task results provided by the example task monitor circuitry 310.

In some examples, and described in connection with FIG. 16, the task update handler circuitry 308 uses two callback handlers with an argument of TaskInfo. The two callback handlers are the completion callback handler 1604 (FIG. 16) (e.g., for when the provisioning task 402 is completed) and the progress callback handler 1606 (FIG. 16) (e.g., for task progress on the provisioning tasks 402). The example callback handler is to act as a placeholder to receive the task results before tasks 402 are completed or after the tasks 402 are completed.

The example task monitor circuitry 310 is to monitor the tasks 402. The example task monitor circuitry 310 is to monitor the different tasks of FIG. 4 (e.g., the clone task 402A, the change power task 402B, the reconfigure task 402C, the snapshot task 402D, or other task 402E). The example task monitor circuitry 310 includes a “monitor task” function which is to pass the results of the “task result extractor” function and the “progress listener” function to the example task update handler circuitry 308.

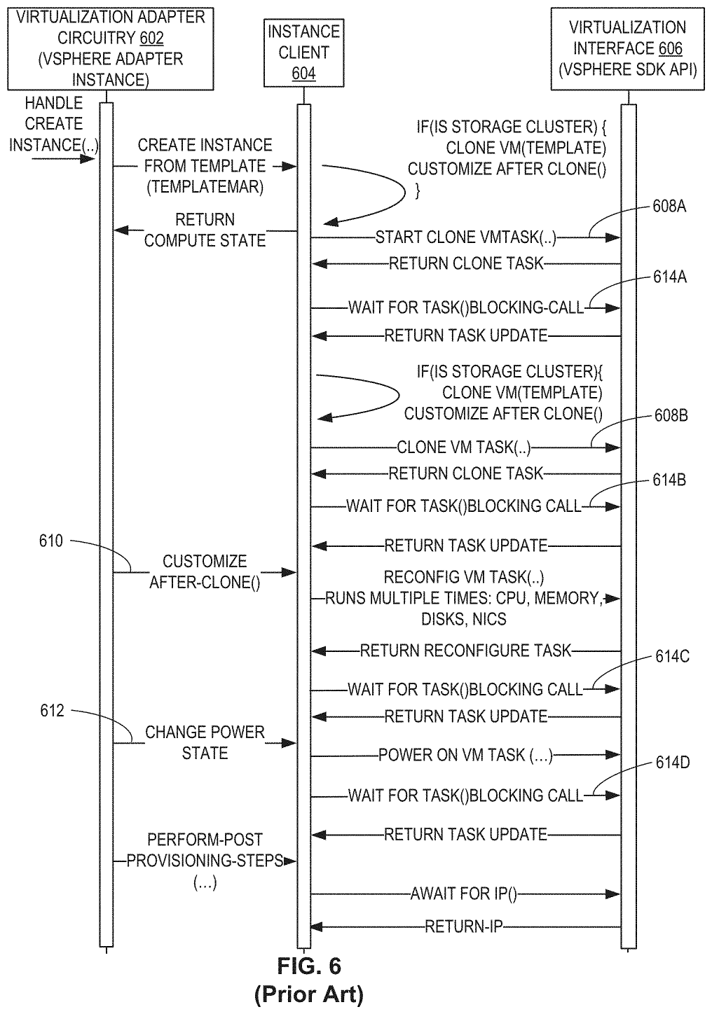

FIG. 6 is a prior technique implemented by prior blocking synchronous provisioning circuitry. In prior, blocking, synchronous systems, a first thread is assigned a first task, and is not allowed to start a second task, until the first task is completed successfully. FIG. 6 includes a virtualization adapter circuitry instance 602 (e.g., prior vSphere adapter instance), an instance client 604, and a virtualization interface 606 (e.g., virtualization software development kit (SDK) API). FIG. 6 illustrates that between different provisioning tasks (e.g., a start clone VM task 608A, a clone VM task 608B, customize after-clone task 610 (e.g., reconfiguration task), a change power task 612, etc.) there are wait-for-task blocking calls 614A-D. A first wait-for-task blocking call 614A waits for the start clone VM task 608A to be completed before the clone VM task 608B can begin.

The virtualization adapter circuitry instance 602 accesses a handle create instance instruction which informs the virtualization adapter circuitry instance 602 to create an instance of a virtual machine from a template. The instance client 604 determines a storage cluster in which to place the instance of the virtual machine. If the current storage cluster is the correct location to provision the instance of the virtual machine, the instance client 604 uses a “clone virtual machine into data store cluster” function and determines to customize the virtual machine after the clone process through multiple uses (e.g., calls) of the “customize after clone” function to reconfigure the storage cluster, thereby creating multiple block calls. If there is not a current storage cluster (not shown in FIG. 6) or the current storage cluster is not the correct location to provision the instance of the virtual machine (not shown in FIG. 6), the instance client 604 uses a clone virtual machine function and then determines to customize the virtual machine after the clone process.

The instance client 604 uses a return function to send the compute state to the virtualization adapter circuitry instance 602. Then the instance client 604 starts the start clone VM task 608A with the virtualization interface 606. The virtualization interface 606 returns the clone task to the instance client 604 after a success or failure. While the virtualization interface 606 is processing the start clone VM task 608A, the first wait-for-task blocking call 614A is started which blocks the start of a thread that could otherwise begin provisioning of the other provisioning tasks. A task update is accessed by the instance client 604 from the virtualization interface 606. In this prior technique of FIG. 6, only one update corresponding to one task is accessible at one time. The technique of FIG. 6 must wait for a current task to resolve as evidenced by the wait-for-task blocking calls 614A-D before starting other tasks. In FIG. 6, a wait-for-task blocking call 614A-D blocks the provisioning thread because the wait-for-task blocking call 614A-D runs in a loop and, if there is no update, the wait-for-task blocking call 614A-D runs again which prevents other provisioning tasks from being started.

In FIG. 6, the clone VM task 608B involves a second wait-for-task blocking call 614B. After the clone VM task 608B resolves, the virtualization interface 606 returns a task update to the instance client 604. Then the instance client 604 begins the customization task 610 which reconfigures the virtual machine multiple times by selecting a central processing unit, memory, disk storage, and networks (e.g., network interface cards). The third wait-for-updated blocking call 614C blocks the thread from starting the change power task 612 until the customization task 610 is completed. After the virtualization interface 606 returns the task update to the instance client 604, the instance client 604 starts the change power task 612 which powers the virtual machine on. The fourth wait-for-task blocking call 614D prevents any post provisioning steps from occurring until the virtualization interface 606 returns the task update to the instance client 604. The virtualization interface 606 performs an “await for IP” function if the virtual machine uses a static Internet Provider (IP) address.

FIG. 6 illustrates a sequence in provisioning a virtual machine. The sequence begins by performing a clone task and a wait for task update corresponding to the clone task, and when the clone task is completed (e.g., done), to use (e.g., call) a customize after clone task. Then another wait for task update (e.g., a wait for updates that corresponds to the customize after clone task) is called. When the customize after clone task is done, a change power state task is used (e.g., called), and a third wait for task update (e.g., a wait for task update that corresponds to the change power task) is called. When the change power task is done, a perform post provisioning steps is called. All of the wait for task update calls are blocking call, which block the current thread. This sequence of clone, wait, customize, wait, change power, wait, perform post provisioning is repeated in several threads in the provisioning of one virtual machine, which implies that the several threads are blocked.

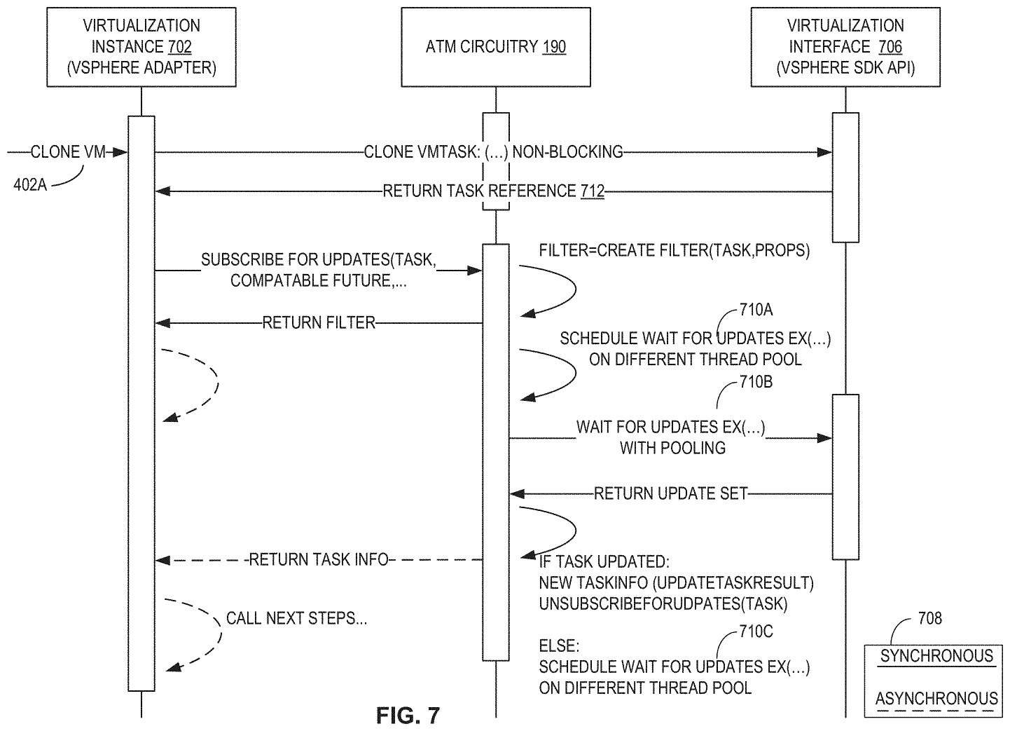

FIG. 7 is an example solution in accordance with techniques disclosed herein that improves over the prior techniques described above in connection with FIG. 6. FIG. 7 includes an example virtualization instance 702 (e.g., vSphere adapter circuitry), the example ATM circuitry 190, and an example virtualization interface 706 (e.g., vSphere SDK API). FIG. 7 includes an example legend 708 which shows that synchronous tasks have a solid line, while asynchronous tasks have a dashed line. The example ATM circuitry 190 is to control the flow of task updates from the example virtualization interface 706 by notifying the example virtualization instance 702 of updates corresponding to the tasks 402 (e.g., operations). Per cloud environment session (e.g., a session during which tasks are used to provision a resource such as a VM provisioned on one of the example cloud environments 406), the example ATM circuitry 190 uses at least one instance of the APC circuitry 302 (FIGS. 3, 4, 5) to generate filters. The filters are generated when a task is sent to the example virtualization instance 702 and the task is removed when the task is completed, or a timer expires.

The example virtualization instance 702 receives a clone VM task 402A from the example provisioning circuitry 160 (FIGS. 1, 2), and the example virtualization instance 702 calls the example virtualization interface 706 with the example clone VM task 402A, where the clone VM task 402A is a non-blocking task. In other examples, the clone VM task 402A may be to clone any other resource and not necessarily to clone a VM (e.g., clone a virtual machine). The example virtualization interface 706 returns a task reference 712 to the example virtualization instance 702. In some examples, the example virtualization interface 706 returns the task reference 712 immediately (e.g., instantaneously) to the example virtualization instance 702 before the clone VM task 402A is started.

The example virtualization instance 702 uses the task reference 712 in the “subscribe for updates” method (e.g., function) with a callback handler (e.g., a handler to store the status once the task 402 is completed) to generate a task subscription 404. The example ATM circuitry 190 uses callback handlers and the task reference 712 received from the example virtualization instance 702 to generate a filter for the task (e.g., the clone VM task 402A). The example ATM circuitry 190 schedules a thread with a given delay to execute an example “wait for updates” function 710A. The example wait for updates function 710A is used by the ATM circuitry 190 to asynchronously request a status update from the virtualization interface 706 about the status of the clone VM task 402A. In some examples, the ATM circuitry 190 schedules the wait for updates function 710A on a different thread pool. In examples disclosed herein, a thread pool is at least two threads used in asynchronous provisioning of tasks. For example, a first task 402 may be halfway through completion of being provisioned by the example provisioning circuitry 160 on a first thread in a thread pool, and the example APC circuitry 302 may uses a second thread to monitor the first task 402 that is being completed on the first thread and monitor other provisioning tasks 402 that are being completed on other threads (e.g., third thread, fourth thread, etc.). The first thread that is used in provisioning the first task 402 may start provisioning a second task. The techniques disclosed herein are efficient because the first thread may be free to receive any requests after the task reference is returned and a call to monitor the second task is called (e.g., the information provider circuitry 304 using a “subscribe for updates” function). The example virtualization instance 702 (e.g., a caller) uses the result of the status update about the clone VM task 402A asynchronously to not block the thread scheduled by the ATM circuitry 190.

The example ATM circuitry 190 periodically or aperiodically polls for status updates on task status from the example virtualization interface 706 by using the wait for updates function 710B. The result of the wait for updates function 710B (e.g., successfully completed, error, termination, 25% completed, etc.) is returned by the virtualization interface 706 to the example ATM circuitry 190 as an update set (e.g., a status update set). In response to the status update about the clone VM task 402A, the example ATM circuitry 190 returns updated task information including the status update to the example virtualization instance 702 and unsubscribes for status updates corresponding to the clone VM task 402A. The example ATM circuitry 190 schedules periodically an example wait for updates function 710C on a the same thread pool, allowing asynchronous provisioning to continue. The thread pool which has the “WaitForUpdatesEx” function is used only to wait for updates, while a different thread pool may be used for executing the provisioning tasks 402 (e.g., clone task 402A (FIG. 4), change power task 402B (FIG. 4), the example reconfigure task 402C (FIG. 4), the example snapshot task 402D (FIG. 4), and/or other tasks 402E (FIG. 4)). After the example virtualization instance 702 receives the updated task information from the example ATM circuitry 190, the example virtualization instance 702 calls the next steps in provisioning. Example next steps include the example change power task 402B, the example reconfigure task 402C, the example snapshot task 402D, and/or other tasks 402E.

In some examples, the wait for updates function 710B, may be executed in a pooling manner. For example, in response to executing the wait for updates function 710B in a pooling manner. As used herein, executing a function using pooling means that the “WaitForUpdatesEx” function 710B is used (e.g., called) multiple times to get updates on provisioning tasks 402.

In some examples, the wait for updates function 710B is executed by the example ATM circuitry 190 while there are still task subscriptions for a current cloud environment session (e.g., current vCenter cloud session) that are waiting for status updates about their corresponding tasks. The example ATM circuitry 190 executes the wait for updates function 710B based on an example “ScheduledThreadPoolExecuter.schedule.”

In some examples, the wait for updates functions 710A, 710B, 710C have a limit on the amount of data transmitted by the example vCenter® virtual infrastructure server 130 (e.g., vCenter cloud provider) as represented by the constant “WaitOptions.maxObjectUpdates” or the constant “WaitOptions.maxWaitSeconds.” The wait for updates functions 710A, 710B, 710C may return truncated status update data to the ATM circuitry 190 and subsequent calls from the ATM circuitry 190 to the example virtualization interface 706 may be used to request the rest of the status update data that was previously over the threshold limit. For example, because property collection may involve retrieval of large amounts of data, depending on the number of properties implied in the collection request. The example vCenter® virtual infrastructure server 130 (e.g., vCenter cloud provider) supports segmented data transmission (e.g., chunking) when sending collected data to the example ATM circuitry 190 (e.g., client, customer, endpoint device). In some examples, if the amount of collected data exceeds the chunk size, the server returns a chunk of data in a single response and indicates that additional data may be retrieved.

In some examples, the “WaitForUpdatesEx” function returns an UpdateSet data object (as described in connection with FIG. 17), and an “UpdateSet.truncated” property indicates whether the example ATM circuitry 190 is to call the “WaitForUpdatesEx” function again to retrieve additional data. If “UpdateSet.truncated” is true, the “WaitForUpdatesEx” function returns a version string to identify chunked data to the ATM circuitry 190. In some examples, after the ATM circuitry 190 receives an indication, from the example vCenter® virtual infrastructure server 130 (e.g., vCenter cloud provider), that additional data is available, the example ATM circuitry 190 may send the returned the version string in the subsequent call to the “WaitForUpdatesEx” function to retrieve the next chunk of data.

In some examples, the limits are specified the API call based on the constant “WaitOptions.maxObjectUpdates” or the constant “WaitOptions.maxWaitSeconds.”

As used herein, the constant “WaitOptions.maxWaitSeconds” is the number of seconds the example APC circuitry 302 is to wait before returning null value. In some examples, returning updates may take longer if an actual calculation time exceeds the value for the constant “WaitOptions.maxWaitSeconds.” In some examples, the policy of the example APC circuitry 302 may return a null value sooner than the time allowed in the constant “WaitOptions.maxWaitSeconds.” In some examples, an unset value causes the “WaitForUpdatesEx” function to wait as long as is possible for updates. However, a policy of the APC circuitry 302 may return null at some point. In some examples, a value of zero causes the “WaitForUpdatesEx” function to do one update calculation and return any updates, which is similar to a “CheckForUpdates” function. In some examples, a positive value causes the “WaitForUpdatesEx” function to return null if no updates are available within the specified number of seconds. The choice of a positive value often depends on a client communication stack. For example, an endpoint user may choose a duration shorter than a local HTTP request timeout. In some examples, the duration is not shorter than a few minutes. A negative value for the constant “WaitOptions.maxWaitSeconds” is not permitted.

In some examples, the APC circuitry 302 (FIGS. 3, 4, 5) of the example ATM circuitry 190 is closed if the cloud environment session (e.g., vCenter cloud session) is closed. In such examples, the filters of the APC circuitry 302 are regenerated by the ATM circuitry 190. To use the property collection function of the APC circuitry 302, the same cloud environment session (e.g., vCenter cloud session) is to be used for the task status updates. After a cloud environment session (e.g., vCenter cloud session) is terminated, the filters that correspond to that cloud environment session are also terminated.

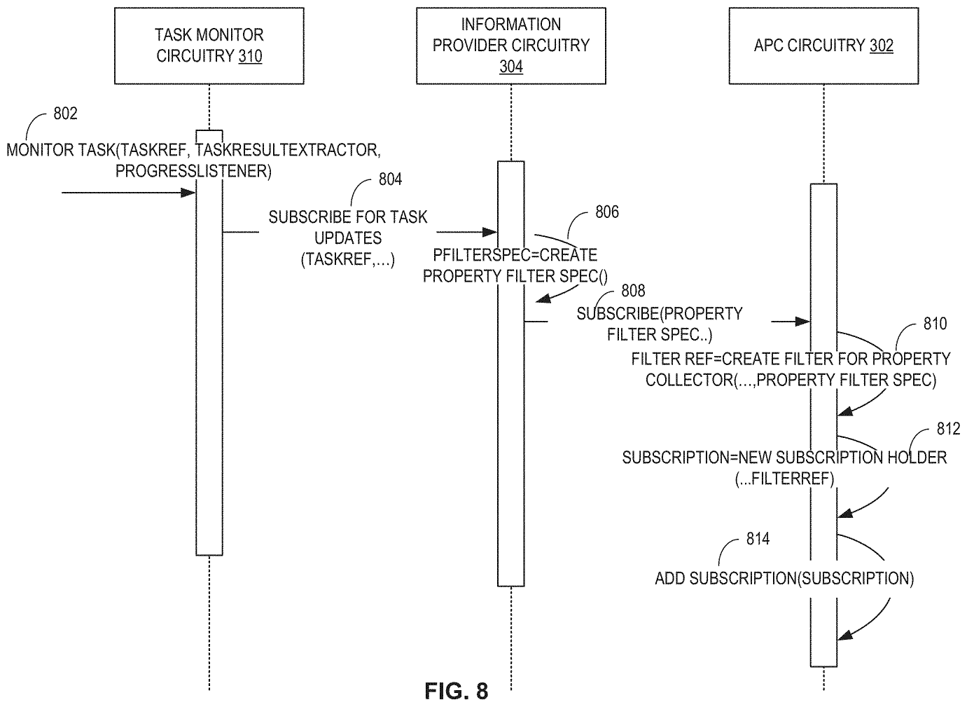

FIG. 8 is an example UML diagram illustrating example calls between the example task monitor circuitry 310, the example information provider circuitry 304, and the example APC circuitry 302 to asynchronously monitor tasks. An example monitor task function 802 is called using client instructions (e.g., a provisioning request) to monitor a provisioning task asynchronously. The example monitor task function 802 includes a task reference identification (“TASKREF”), a task result extractor function (“TASKRESULTEXTRACTOR”), and a progress listener function (“PROGRESSLISTENER”). The example task monitor circuitry 310 receives the task reference identification (“TASKREF”) in the monitor task function 802 from the example information provider circuitry 304. The example task monitor circuitry 310 uses the task reference identification (“TASKREF”) to determine which task to monitor. The example task monitor circuitry 310 uses the task result extractor function (“TASKRESULTEXTRACTOR”) to access completion status update results of provisioning tasks such as success, failure, early termination. The example task monitor circuitry 310 uses the progress listener function (“PROGRESSLISTENER”) to determine different progress levels of provisioning tasks such as twenty-five percent (25%) provisioned or ninety percent (90%) provisioned.

The example information provider circuitry 304 subscribes to the tasks to monitor by using an example subscribe for task update function 804. The example task reference identification (“TASKREF”) in the example “subscribe for task update” function 804 instructs the example task monitor circuitry 310 to continue to monitor the corresponding task. In some examples, after a provisioning task is completed, the example information provider circuitry 304 may unsubscribe that provisioning task from further task updates. For example, the information provider circuitry 304 may remove the task reference identification (“TASKREF”) of the completed task from the task subscription 404. In some examples, such removing of the task reference identification from the task subscription 404 also removes the task subscription 404 from the subscription manager circuitry 306 (e.g., when there are no more task reference identifications subscribed in the task subscription 404. In examples disclosed herein, removing the task reference identification from the task subscription 404 is an indication to the example task monitor circuitry 310 to cease monitoring that task.

The example information provider circuitry 304 uses an example “create property filter spec” function 806 to generate an instance of a property filter to asynchronously monitor a currently executing task. The example information provider circuitry 304 sends the instance of the property filter (“PFILTERSPEC”) in a “subscribe” function 808 to the example APC circuitry 302.

The example APC circuitry 302 uses the instance of the property filter (“PFILTERSPEC”) in an example create filter for property collector function 810. The example APC circuitry 302 uses the create filter for property collector function 810 to generate a filter reference identification (“FILTERREF”). The example APC circuitry 302 uses the filter reference identification (“FILTERREF”) to generate a new subscription using an example subscription holder function 812. The example APC circuitry 302 adds the newly generated subscription to active subscriptions in the list of the subscription manager circuitry 306 (FIG. 3) using an add subscription function 814. The newly generate subscription refers to tasks that have been filtered and are monitored by the example task monitor circuitry 310.

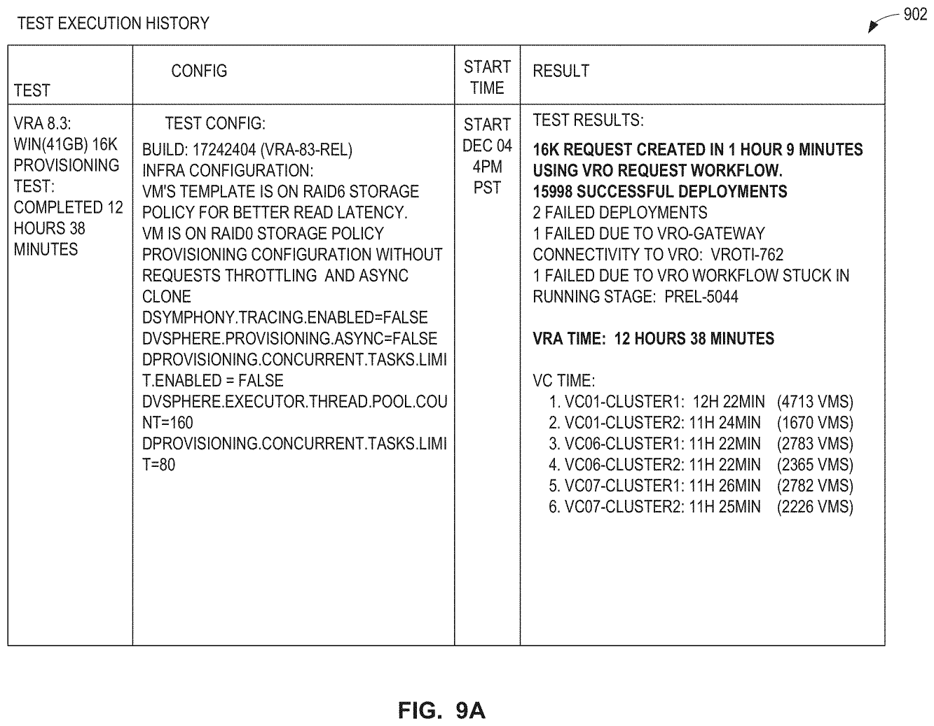

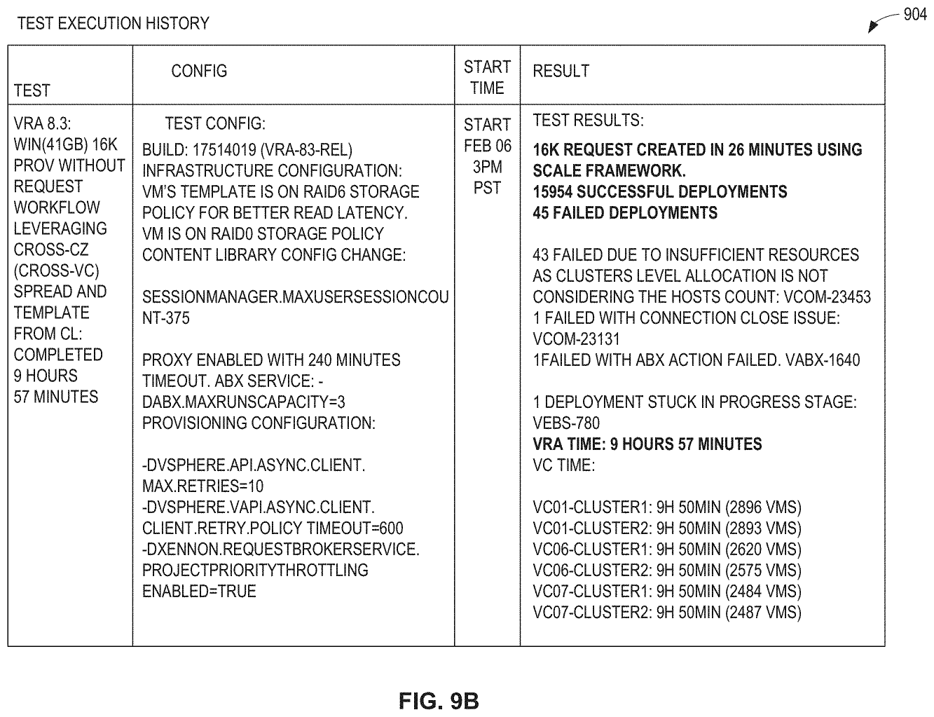

FIG. 9A illustrates an example first provisioning test 902 run using the example ATM circuitry 190 of FIGS. 1 and 3 before optimizing the ATM circuitry 190 for optimal performance. Results of the example first provisioning test 902 show that the time to request provisioning of sixteen thousand (“16,000”) virtual machines was two hours and five minutes and that the time for vRealize Automation® cloud management platform 140 to complete the provisioning was 12 hours and 38 minutes. Of these 16,000 provisioning requests, 15,998 provisioning requests were successfully completed and two (‘2’) provisioning requests failed.

FIG. 9B illustrates an example second provisioning test 904 run using the example ATM circuitry 190 of FIGS. 1 and 3 after optimizing the ATM circuitry 190 for better performance than observed for the provisioning test 902 of FIG. 9A. Results of the example second provisioning test 904 show that the time to request provisioning of sixteen thousand (“16,000”) virtual machines was 26 minutes and that the time for vRealize Automation® cloud management platform 140 to complete the provisioning was 9 hours and 57 minutes. Of the 16,000 provisioning requests, 15954 were successfully completed and forty-five (“45”) provisioning requests had failed. The example second provisioning test 904 illustrates how the example ATM circuitry 190 is able to asynchronously provision more requests than before with the first provisioning test 902. The improved performance achieved with the second provisioning test 904 was achieved because the number of threads used to request machines to provision in the example vCenter® virtual infrastructure server 130 (e.g., vCenter cloud provider) is limited. If the threads are blocked as in the prior solution of FIG. 6, the threads wait until the example virtualization adapter circuitry 232, which is configured to work with the example vCenter® virtual infrastructure server 130 (e.g., vCenter cloud provider), completes a current operation and then the threads will get unblocked and the threads can then be used to make additional requests to the virtualization adapter circuitry 232 to provision more machines. In the techniques disclosed herein, the threads are not blocked. Once the threads send requests for machines to the example virtualization adapter circuitry 232, which is configured to work with the example vCenter® virtual infrastructure server 130 (e.g., vCenter cloud provider), the threads are not required to wait until the example vCenter® virtual infrastructure server 130 (e.g., vCenter cloud provider) completes the operation and the threads can make more requests to the example vCenter® virtual infrastructure server 130 (e.g., vCenter cloud provider). In some examples, the polling uses only one thread to poll for updates/progress from the example vCenter® virtual infrastructure server 130 (e.g., vCenter cloud provider) in a task schedule.

FIG. 10 is a flowchart representative of example machine readable instructions and/or example operations 1000 that may be executed and/or instantiated by processor circuitry to implement the ATM circuitry 190 (FIGS. 1 and 3) to asynchronously monitor at least one provisioning task. The machine readable instructions and/or the operations 1000 of FIG. 10 begin at block 1002, at which the example task monitor circuitry 310 (FIGS. 3, 4, 5) monitors one or more provisioning tasks (e.g., one of the tasks 402 of FIG. 4). For example, the example task monitor circuitry 310 may monitor the provisioning task 402 by using a progress listener function to determine the progress of the provisioning task 402 during execution of the provisioning task 402, and by using a task result extractor function to determine the completion status of the provisioning task 402 after the provisioning task 402 is completed. For example, the progress listener function may determine that the provisioning task 402 is partially completed or twenty-five percent (25%) completed. The example task result extractor function may determine that the provisioning task 402 was successfully completed, failed, or early terminated (e.g., early terminated due to a timeout).

At block 1004, the example information provider circuitry 304 (FIGS. 3, 4, 5) generates a task subscription 404 (FIG. 4) in response to a determination to monitor the one or more provisioning tasks 402. For example, the information provider circuitry 304 may generate the task subscription 404 by creating the task subscription 404 as an entry in the example subscription manager circuitry 306 (FIGS. 3, 5). In some examples, the task subscription 404 includes a task reference identification, and the type of updates (e.g., progress updates or completion updates) that the example APC circuitry 302 has determined to monitor.

At block 1006, the example asynchronous property collector (APC) circuitry 302 (FIGS. 3, 4, 5) creates a property filter in the example task subscription 404. For example, the APC circuitry 302 may generate a property filter by determining which provisioning task(s) 402 are being executed on the example cloud environments 406 of FIG. 4. In some examples, the APC circuitry 302 may create a property filter based on the different cloud environments 406 on which the provisioning tasks 402 are being executed (e.g., a first filter corresponding to a first cloud environment 406A).

At block 1008, the APC circuitry 302 requests an indication of availability of a status update corresponding to one or more provisioning tasks 402 based on the property filter. For example, the APC circuitry 302 may poll the vCenter® virtual infrastructure server 130 to request an indication of whether one or more status update(s) for one or more provisioning tasks 402 is/are available to be provided by the vCenter® virtual infrastructure server 130. For example, a status update may include a progress status update or a completion status update depending on a policy set by an endpoint user regarding the kind of status updates of interest for the provisioning tasks 402. In some examples, the APC circuitry 302 periodically or aperiodically requests the status updates.

At block 1010, the APC circuitry 302 asynchronously provisions a second provisioning task that is not blocked by the one or more provisioning tasks 402. For example, the APC circuitry 302 may asynchronously provisions a second provisioning task that is not blocked by the one or more provisioning tasks 402 by scheduling the second provisioning task on a second thread. For example, the APC circuitry 302 can asynchronously schedule more example tasks 402 (FIG. 4) to be executed by designating different threads or cloud environments 406 (FIG. 4) that can execute the additional example tasks 402 (e.g., request additional virtual machines, execute Day-2 tasks) because the threads are not blocked. As described above, a Day-2 task includes a task that occurs after the initial provisioning of the virtual machine.

At block 1012, in response to an indication of availability of the status update, the APC circuitry 302 invokes a callback corresponding to a first completion status update or a first progress status update. For example, the APC circuitry 302 may submit a request to a callback handler (e.g., a callback handler executed by the task monitor circuitry 310) to obtain one or more status update(s) corresponding to one or more of the provisioning tasks 402. The status update(s) returned by the callback handler may be one or more first completion status update(s) or first progress status update(s). A completion status update means a provisioning task 402 is completed such that a corresponding thread that was used for the provisioning task 402 is no longer busy, and the example APC circuitry 302 can use that thread to schedule another provisioning task 402. A progress status update is used to inform the APC circuitry 302 of a percentage of completion of a provisioning task 402 meaning that the provisioning task 402 is not yet complete. The example instructions 1000 end.

FIG. 11 is a flowchart representative of example machine readable instructions and/or example operations 1100 that may be executed and/or instantiated by processor circuitry to implement the ATM circuitry 190 (FIGS. 1 and 3) to asynchronously monitor provisioning tasks. The machine readable instructions and/or the operations 1100 of FIG. 11 begin at block 1102, at which the example task monitor circuitry 310 (FIGS. 3, 4, 5) monitors at least one provisioning task (e.g., one of the tasks 402 of FIG. 4). For example, a provisioning task 402 may be started by the example APC circuitry 302 (FIGS. 3, 4, 5), and the example task monitor circuitry 310 monitors statuses of the task 402.

At block 1104, the example information provider circuitry 304 (FIGS. 3, 4, 5A, 5B, 8) creates (e.g., generates) a task subscription 404 (FIG. 4) for the task 402 subscribing for task updates. The example information provider circuitry 304 may create the task subscription 404 to include a task identifier or task name, and a progress callback or completion callback. For example, a task subscription 404 includes both information about the provisioning task 402 and the example callback to be used to request status updates about the provisioning task 402. For example, the task subscription 404, may include the name (e.g., identifier) of the task 402 (e.g., TaskID=“Task 4125”), and the callback status identifier (ProgressCallback=<percentage complete>) or (CompletionCallback=<success, error, terminated>).

At block 1106, the example APC circuitry 302 determines if there is a filter. For example, in response to the APC circuitry 302 determining there is not a filter (e.g., “NO”), control advances to block 1108. Alternatively, in response to the APC circuitry 302 determining there is a filter (e.g., “YES”), control advances to block 1110.

At block 1108, the example APC circuitry 302 creates a filter at block 1108. For example, the APC circuitry 302 may create a filter by adding the task reference (e.g., taskRef) of the provisioning task 402 to the task subscription 404. However, if there currently are no active provisioning tasks 402, the example APC circuitry 302 may generate the filter at block 1108 so that provisioning tasks 402 started at a later time may be subsequently added to the filter.

At block 1110, the example APC circuitry 302 updates the filter by adding the provisioning task 402 to the filter. In some examples, the filter may already be configured to monitor other tasks when the APC circuitry 302 updates the filter at block 1110 by adding the provisioning task 402 to the filter. Control advances to block 1112.

At block 1112, the example APC circuitry 302 polls for updates from the vCenter virtual infrastructure server 130. For example, the APC circuitry 302 may periodically (e.g., on a schedule), or a aperiodically, poll for updates regarding the provisioning tasks 402 that are being executed on different threads. For example, one thread is for monitoring, while other threads may be used for provisioning.

At block 1114, the example APC circuitry 302 determines if there are task status updates. For example, the APC circuitry 302 may determine if there are task status updates based on a notification from the information provider circuitry 304, which receives the notification from the task monitor circuitry 310. In response to determining there is not an update (e.g., “NO”) control advances to block 1120. Alternatively, in response to determining there is an update (e.g., “YES”), control advances to block 1118.

At block 1120, in response to not receiving a task update, the example APC circuitry 302 continues to wait for updates. For example, the APC circuitry 302 may wait for task status updates based on the “WaitForUpdatesEx” function (e.g., in a non-blocking or asynchronous manner). Control advances to block 1114.

At block 1118, the example APC circuitry 302 invokes callbacks in response to receiving a task update. For example, the APC circuitry 302 may invoke the progress callback handler to determine the progress of the task 402 (e.g., 25%, 50%) or a completion callback handler to determine the status of the task 402 (e.g., success, failure).

At block 1122, the example APC circuitry 302 instructs the example information provider circuitry 304 to delete the taskRef identifier from the task subscription 404. For example, after the task 402 is completed, the information provider circuitry 304 may delete the entry corresponding to the completed provisioning task 402 in the task subscription from the example subscription manager circuitry 306. The instructions 1100 end.

FIG. 12 is a block diagram of an example processor platform 1200 structured to execute and/or instantiate the machine readable instructions and/or the operations of FIGS. 10 and 11 to implement the ATM circuitry 190 of FIG. 3. The processor platform 1200 can be, for example, a server, a personal computer, a workstation, a self-learning machine (e.g., a neural network), or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements example asynchronous property collector (APC) circuitry 302, example information provider circuitry 304, subscription manager circuitry 306, example task update handler circuitry 308, and the example task monitor circuitry 310.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1232, which may be implemented by the machine readable instructions of FIGS. 10 and 11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a general purpose microprocessor 1300. The general purpose microprocessor circuitry 1300 executes some or all of the machine readable instructions of the flowcharts of FIGS. 10 and 11 to effectively instantiate the circuitry of FIG. 3 as logic circuits to perform the operations corresponding to those machine readable instructions. In some such examples, the circuitry of FIG. 3 is instantiated by the hardware circuits of the microprocessor 1300 in combination with the instructions. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 10 and 11.

The cores 1302 may communicate by a first example bus 1304. In some examples, the first bus 1304 may implement a communication bus to effectuate communication associated with one(s) of the cores 1302. For example, the first bus 1304 may implement at least one of an Inter-Integrated Circuit (I2C) bus, a Serial Peripheral Interface (SPI) bus, a PCI bus, or a PCIe bus. Additionally or alternatively, the first bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_ cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may implement at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

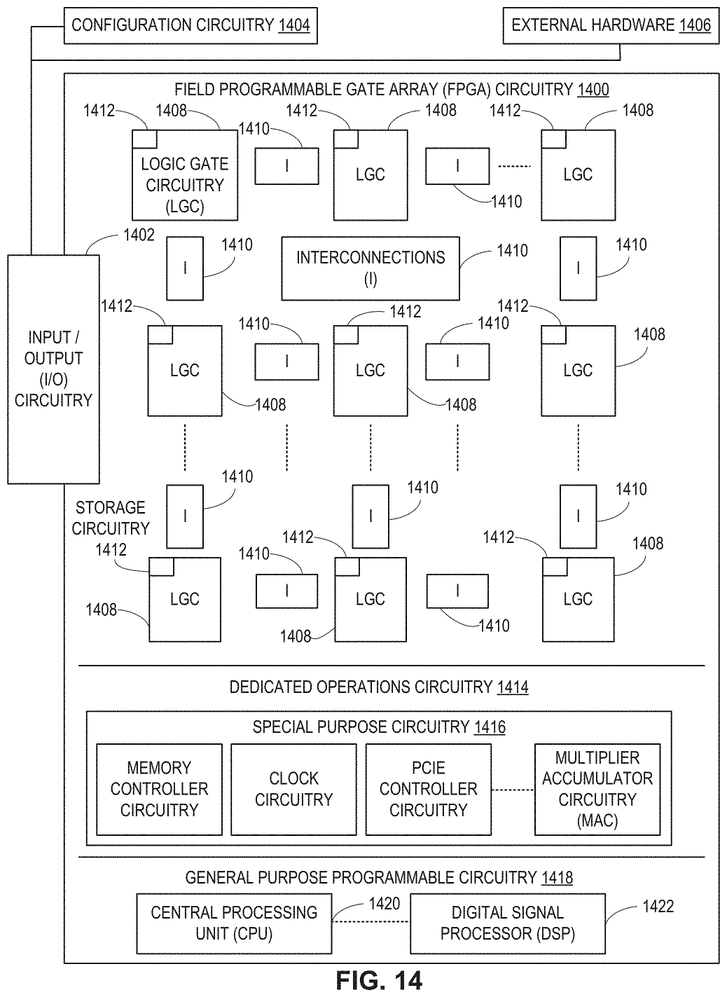

FIG. 14 is a block diagram of another example implementation of the processor circuitry 1212 of FIG. 12. In this example, the processor circuitry 412 is implemented by FPGA circuitry 1400. The FPGA circuitry 1400 can be used, for example, to perform operations that could otherwise be performed by the example microprocessor 1300 of FIG. 5 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 10 and 11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 10 and 11. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 10 and 11. As such, the FPGA circuitry 1400 may be structured to effectively instantiate some or all of the machine readable instructions of the flowcharts of FIGS. 10 and 11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 10 and 11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 10 and 11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 10 and 11 may be executed by one or more of the cores 1302 of FIG. 13, a second portion of the machine readable instructions represented by the flowcharts of FIGS. 10 and 11 may be executed by the FPGA circuitry 1400 of FIG. 14, and/or a third portion of the machine readable instructions represented by the flowcharts of FIGS. 10 and 11 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 1212 of FIG. 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

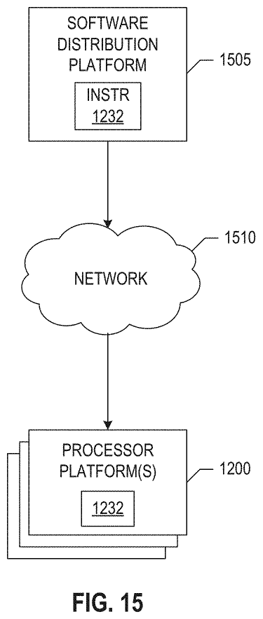

A block diagram illustrating an example software distribution platform 1505 to distribute software such as the example machine readable instructions 1232 of FIG. 15 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 1000 of FIG. 10 or 1100 of FIG. 11, as described above. The one or more servers of the example software distribution platform 1505 are in communication with a network 1510, which may correspond to any one or more of the Internet and/or any of the example networks 1510 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 1000 of FIG. 10 or 1100 of FIG. 11, may be downloaded to the example processor platform 1200, which is to execute the machine readable instructions 1232 to implement the ATM circuitry 190 of FIGS. 1-2. In some example, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

FIG. 16 shows example machine readable instructions 1600 that when executed instantiate a callback handler. The example machine readable instructions 1600 are presented in Java, but any suitable programming language may be used. As used herein, in connection with FIG. 16, a callback handler used by the example task update handler circuitry 308 to request status updates from the example task monitor circuitry 310. The results of the example task monitor circuitry 310 are provided to the task update handler circuitry 308 via the example callback handler. As illustrated in FIG. 16, the example “monitor task” function 1602 includes a completion callback handler 1604 and a progress callback handler 1606. The example “monitor task” function 1602 receives the task information from the completion callback handler 1604 (e.g., a task information callback handler, a first lambda function that logs a state of the task 402 after completion of the task 402). For example, for a first provisioning task 402 identified by the task reference (e.g., identifier “taskRef”), the task information from the completion callback handler 1604 may indicate that the first provisioning task 402 is completed with a state (e.g., successfully completed, cancelled, failed). The example “monitor task” function 1602 receives progress information from the progress callback handler 1606 (e.g., a second lambda function that logs the progress of the task 402). For example, for the first provisioning task 402 identified by the task reference, the task information from the progress callback handler 1606 may indicate the progress of the first provisioning task 402 (e.g., 25% complete, 50% completed, etc.).

FIG. 17 is a class diagram that may be used to describe the features of an UpdateSet in accordance with teachings of this disclosure. An UpdateSet class may be used by the example callback handlers described above in connection with FIG. 16 to provide completion updates and/or progress updates for monitored tasks. In the example of FIG. 17, the example “UpdateSet” 1702 includes an example property filter update 1704, an example object update 1706, an example property change 1708, an example property change Op 1710, an example missing object 1712, an example object update kind 1714, and an example missing property 1716.

From the foregoing, it will be appreciated that example systems, methods, apparatus, and articles of manufacture have been disclosed that asynchronously monitoring at least one provisioning task. Disclosed systems, methods, apparatus, and articles of manufacture improve the efficiency of using a computing device by allowing asynchronous provisioning of virtual machines which reduces wasted time due to synchronous provisioning. The disclosed systems, methods, apparatus, and articles of manufacture allow for provisioning of virtual machines by using a non-blocking methods in task monitoring which allows more tasks to be provisioned at one time in the generation of virtual machines. Disclosed systems, methods, apparatus, and articles of manufacture are accordingly directed to one or more improvement(s) in the operation of a machine such as a computer or other electronic and/or mechanical device.

Examples disclosed herein advantageously improve the efficiency of monitoring provisioning tasks including long running provisioning tasks that run a significantly long time for a duration during which other provisioning tasks are requested. Since examples disclosed herein implement non-blocking, asynchronous monitoring, such other requested provisioning tasks can run even while a long running provisioning task is concurrently running.

Example methods, apparatus, systems, and articles of manufacture to asynchronously monitor provisioning tasks are disclosed herein. Further examples and combinations thereof include the following:

Example 1 includes an apparatus to asynchronously monitor one or more provisioning tasks, the apparatus comprising task monitor circuitry to monitor the one or more provisioning tasks, information provider circuitry to generate a task subscription corresponding to the one or more provisioning tasks, and asynchronous property collector circuitry to create a property filter in the task subscription, request an indication of availability of a status update corresponding to the one or more provisioning tasks based on the property filter, asynchronously provision a second provisioning task that is not blocked by the one or more provisioning tasks, and in response to the availability of the status update, invoke a callback corresponding to a first completion status update or a first progress status update.

Example 2 includes the apparatus of example 1, wherein the information provider circuitry is to receive the first progress status update corresponding to a first provisioning task and the first completion status update corresponding to the first provisioning task.

Example 3 includes the apparatus of example 2, wherein the asynchronous property collector circuitry is to use the property filter to group the first completion status update with a second completion status update based on first properties of the first completion status update and second properties of the second completion status update, and group the first progress status update with a second progress status update based on third properties of the first progress status update and fourth properties of the second progress status update.

Example 4 includes the apparatus of example 2, wherein the first completion status update includes at least one of a success indication, an error indication, a terminated indication, or a progress indication.

Example 5 includes the apparatus of example 2, wherein the information provider circuitry is to remove a task reference from the task subscription in response to the first completion status update, the task reference corresponding to the first provisioning task.

Example 6 includes the apparatus of example 5, wherein the information provider circuitry is to cancel the task subscription from subscription manager circuitry in response to the first completion status update.

Example 7 includes the apparatus of example 1, wherein the asynchronous property collector circuitry is to filter the one or more provisioning tasks based on a task reference.

Example 8 includes the apparatus of example 1, wherein the asynchronous property collector circuitry is to filter the one or more provisioning tasks based on a cloud environment in which the one or more provisioning tasks are executed.

Example 9 includes the apparatus of example 1, wherein the asynchronous property collector circuitry is to use the filter to retrieve a plurality of status updates corresponding to the one or more provisioning tasks, the one or more provisioning tasks submitted to a cloud environment by the asynchronous property collector circuitry.

Example 10 includes the apparatus of example 1, wherein the apparatus is to monitor one or more long running provisioning tasks.

Example 11 includes a non-transitory computer readable medium comprising instructions that, when executed, cause processor circuitry to at least monitor the one or more provisioning tasks, generate a task subscription corresponding to the one or more provisioning tasks, create a property filter in the task subscription, request an indication of availability of a status update corresponding to the one or more provisioning tasks based on the property filter, asynchronously provision a second provisioning task that is not blocked by the one or more provisioning tasks, and in response to the availability of the status update, invoke a callback corresponding to a first completion status update or a first progress status update.

Example 12 includes the non-transitory computer readable medium of example 11, wherein the processor circuitry is to receive the first progress status update corresponding to a first provisioning task and the first completion status update corresponding to the first provisioning task.

Example 13 includes the non-transitory computer readable medium of example 12, wherein the processor circuitry is to use the property filter to group the first completion status update with a second completion status update based on first properties of the first completion status update and second properties of the second completion status update, and group the first progress status update with a second progress status update based on third properties of the first progress status update and fourth properties of the second progress status update.

Example 14 includes the non-transitory computer readable medium of example 12, wherein the first completion status update includes at least one of a success indication, an error indication, a terminated indication, or a progress indication.

Example 15 includes the non-transitory computer readable medium of example 12, wherein the processor circuitry is to remove a task reference from the task subscription in response to the first completion status update, the task reference corresponding to the first provisioning task.

Example 16 includes the non-transitory computer readable medium of example 15, wherein the processor circuitry is to cancel the task subscription in response to the first completion status update.

Example 17 includes the non-transitory computer readable medium of example 11, wherein the processor circuitry is to filter the one or more provisioning tasks based on a task reference.

Example 18 includes the non-transitory computer readable medium of example 11, wherein the processor circuitry is to filter the one or more provisioning tasks based on a cloud environment in which the one or more provisioning tasks are executed.

Example 19 includes the non-transitory computer readable medium of example 11, wherein the processor circuitry is to use the filter to retrieve a plurality of status updates corresponding to the one or more provisioning tasks, the one or more provisioning tasks submitted to a cloud environment by the processor circuitry.

Example 20 includes the non-transitory computer readable medium of example 11, wherein the processor circuitry is to monitor one or more long running provisioning tasks.

Example 21 includes a method to asynchronously monitor one or more provisioning tasks, the method comprising monitoring the one or more provisioning tasks, generating a task subscription corresponding to the one or more provisioning tasks, creating a property filter in the task subscription, requesting an indication of availability of a status update corresponding to the one or more provisioning tasks based on the property filter, asynchronously provisioning a second provisioning task that is not blocked by the one or more provisioning tasks, and in response to the availability of the status update, invoking a callback corresponding to a first completion status update or a first progress status update.

Example 22 includes the method of example 23, wherein the method further includes receiving the first progress status update corresponding to a first provisioning task and the first completion status update corresponding to the first provisioning task.

Example 23 includes the method of example 22, wherein the method further includes using the property filter to group the first completion status update with a second completion status update based on first properties of the first completion status update and second properties of the second completion status update, and group the first progress status update with a second progress status update based on third properties of the first progress status update and fourth properties of the second progress status update.

Example 24 includes the method of example 22, wherein the first completion status update includes at least one of a success indication, an error indication, a terminated indication, or a progress indication.

Example 25 includes the method of example 22, wherein the method further includes removing a task reference from the task subscription in response to the first completion status update, the task reference corresponding to the first provisioning task.

Example 26 includes the method of example 25, wherein the method further includes cancelling the task subscription from memory in response to the first completion status update.

Example 27 includes the method of example 21, wherein the method further includes filtering the one or more provisioning tasks based on a task reference.

Example 28 includes the method of example 21, wherein the method further includes filtering the one or more provisioning tasks based on a cloud environment in which the one or more provisioning tasks are executed.

Example 29 includes the method of example 21, wherein the one or more provisioning tasks were submitted to a cloud environment, the method further including using the filter to retrieve a plurality of status updates corresponding to the one or more provisioning tasks.

Example 30 includes the method of example 21, wherein the method further includes monitoring one or more long running provisioning tasks.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to asynchronously monitor one or more provisioning tasks, the apparatus comprising:
task monitor circuitry to monitor the one or more provisioning tasks;
information provider circuitry to generate a task subscription corresponding to the one or more provisioning tasks; and
asynchronous property collector circuitry to:
create a property filter in the task subscription;
request an indication of availability of a status update corresponding to the one or more provisioning tasks based on the property filter;
asynchronously provision a second provisioning task that is not blocked by the one or more provisioning tasks; and
in response to the availability of the status update, invoke a callback corresponding to a first completion status update or a first progress status update.

2. The apparatus of claim 1, wherein the information provider circuitry is to receive the first progress status update corresponding to a first provisioning task and the first completion status update corresponding to the first provisioning task.

3. The apparatus of claim 2, wherein the asynchronous property collector circuitry is to use the property filter to:
group the first completion status update with a second completion status update based on first properties of the first completion status update and second properties of the second completion status update; and
group the first progress status update with a second progress status update based on third properties of the first progress status update and fourth properties of the second progress status update.

4. The apparatus of claim 2, wherein the first completion status update includes at least one of a success indication, an error indication, a terminated indication, or a progress indication.

5. The apparatus of claim 2, wherein the information provider circuitry is to remove a task reference from the task subscription in response to the first completion status update, the task reference corresponding to the first provisioning task.

6. The apparatus of claim 5, wherein the information provider circuitry is to cancel the task subscription from subscription manager circuitry in response to the first completion status update.

7. The apparatus of claim 1, wherein the asynchronous property collector circuitry is to filter the one or more provisioning tasks based on a task reference.

8. The apparatus of claim 1, wherein the asynchronous property collector circuitry is to filter the one or more provisioning tasks based on a cloud environment in which the one or more provisioning tasks are executed.

9. The apparatus of claim 1, wherein the asynchronous property collector circuitry is to use the filter to retrieve a plurality of status updates corresponding to the one or more provisioning tasks, the one or more provisioning tasks submitted to a cloud environment by the asynchronous property collector circuitry.

10. The apparatus of claim 1, wherein the apparatus is to monitor one or more long running provisioning tasks.

11. A non-transitory computer readable medium comprising instructions that, when executed, cause processor circuitry to at least:
monitor the one or more provisioning tasks;
generate a task subscription corresponding to the one or more provisioning tasks;
create a property filter in the task subscription;
request an indication of availability of a status update corresponding to the one or more provisioning tasks based on the property filter;
asynchronously provision a second provisioning task that is not blocked by the one or more provisioning tasks; and
in response to the availability of the status update, invoke a callback corresponding to a first completion status update or a first progress status update.

12. The non-transitory computer readable medium of claim 11, wherein the processor circuitry is to receive the first progress status update corresponding to a first provisioning task and the first completion status update corresponding to the first provisioning task.

13. The non-transitory computer readable medium of claim 12, wherein the processor circuitry is to use the property filter to:
group the first completion status update with a second completion status update based on first properties of the first completion status update and second properties of the second completion status update; and
group the first progress status update with a second progress status update based on third properties of the first progress status update and fourth properties of the second progress status update.

14. The non-transitory computer readable medium of claim 12, wherein the first completion status update includes at least one of a success indication, an error indication, a terminated indication, or a progress indication.

15. The non-transitory computer readable medium of claim 12, wherein the processor circuitry is to remove a task reference from the task subscription in response to the first completion status update, the task reference corresponding to the first provisioning task.

16. The non-transitory computer readable medium of claim 15, wherein the processor circuitry is to cancel the task subscription in response to the first completion status update.

17. The non-transitory computer readable medium of claim 11, wherein the processor circuitry is to filter the one or more provisioning tasks based on a task reference.

18. The non-transitory computer readable medium of claim 11, wherein the processor circuitry is to filter the one or more provisioning tasks based on a cloud environment in which the one or more provisioning tasks are executed.

19. The non-transitory computer readable medium of claim 11, wherein the processor circuitry is to use the filter to retrieve a plurality of status updates corresponding to the one or more provisioning tasks, the one or more provisioning tasks submitted to a cloud environment by the processor circuitry.

20. The non-transitory computer readable medium of claim 11, wherein the processor circuitry is to monitor one or more long running provisioning tasks.

21. A method to asynchronously monitor one or more provisioning tasks, the method comprising:
monitoring the one or more provisioning tasks;
generating a task subscription corresponding to the one or more provisioning tasks;
creating a property filter in the task subscription;
requesting an indication of availability of a status update corresponding to the one or more provisioning tasks based on the property filter;
asynchronously provisioning a second provisioning task that is not blocked by the one or more provisioning tasks; and
in response to the availability of the status update, invoking a callback corresponding to a first completion status update or a first progress status update.

22. The method of claim 23, wherein the method further includes receiving the first progress status update corresponding to a first provisioning task and the first completion status update corresponding to the first provisioning task.

23. The method of claim 22, wherein the method further includes using the property filter to:
group the first completion status update with a second completion status update based on first properties of the first completion status update and second properties of the second completion status update; and
group the first progress status update with a second progress status update based on third properties of the first progress status update and fourth properties of the second progress status update.

24. The method of claim 22, wherein the first completion status update includes at least one of a success indication, an error indication, a terminated indication, or a progress indication.

25. The method of claim 22, wherein the method further includes removing a task reference from the task subscription in response to the first completion status update, the task reference corresponding to the first provisioning task.

26-30. (canceled)
